(19) United States
(12) Patent Application Publication
(10) Pub. No.: US 2020/0292983 A1
(43) Pub. Date: Sep. 17, 2020

(54) IMAGE FORMING APPARATUS

(71) Applicant: FUJI XEROX CO., LTD., Tokyo (JP)

(72) Inventors: Shota OSHIMA, Kanagawa (JP); Masataka KURIBAYASHI, Kanagawa (JP); Makoto KAMISAKI, Kanagawa (JP); Jun SEKIYA, Kanagawa (JP)

(73) Assignee: FUJI XEROX CO., LTD., Tokyo (JP)

(21) Appl. No.: 16/554,696

(22) Filed: Aug. 29, 2019

(30) Foreign Application Priority Data
Mar. 15, 2019 (JP) 2019-048827

(51) Int. Cl. G03G 21/00

(52) U.S. Cl. CPC G03G 21/0011

(57) ABSTRACT

An image forming apparatus includes: an image holding member; a charging unit that charges a surface of the image holding member; an electrostatic image forming unit that forms an electrostatic image on the charged surface of the image holding member; a developing unit that houses a toner for electrostatic image development and develops the electrostatic image formed on the surface of the image holding member with the toner to thereby form a toner image; a transfer unit that transfers the toner image formed on the surface of the image holding member onto a surface of a recording medium; a cleaning unit that includes a cleaning blade and cleans the surface of the image holding member; and a fixing unit that fixes the toner image transferred onto the surface of the recording medium. The cleaning blade has a contact portion that contacts the surface of the image holding member, the contact portion having a JIS-A hardness of from 90° to 130° inclusive. The toner for electrostatic image development satisfies the following formulas:

(ln η(T1)−ln η(T2))/(T1−T2)≤−0.14;

(ln η(T2)−ln η(T3))/(T2−T3)≥−0.15; and

(ln η(T1)−ln η(T2))/(T1−T2)<(ln η(T2)−ln η(T3))/(T2−T3),

wherein η(T1) is the viscosity of the toner at 60° C., η(T2) is the viscosity of the toner at 90° C., and η(T3) is the viscosity of the toner at 130° C.

### CROSS-REFERENCE TO RELATED APPLICATION

This application is based on and claims priority under 35 USC 119 from Japanese Patent Application No. 2019-048827 filed Mar. 15, 2019.

### BACKGROUND

### Technical Field

The present disclosure relates to an image forming apparatus.

### Related Art

Visualization methods, such as an electrophotographic method, which visualize image information through electrostatic images are currently used in various fields.

In a conventional electrophotographic method commonly used, image information is visualized through the steps of: forming electrostatic latent images on surfaces of photoconductors using various means; causing electroscopic particles referred to as toner to adhere to the electrostatic latent images to develop the electrostatic latent images (toner images); transferring the developed images onto the surface of a transfer body; and fixing the images by, for example, heating.

Japanese Laid Open Patent Application Publication No. 2004-354527 discloses a cleaning device used for electrophotographic image forming apparatuses such as duplicators, printers, facsimiles, and multi-function devices. This cleaning device removes substances adhering to a member to be cleaned using a cleaning blade. The cleaning blade includes a plurality of layers formed of materials with different characteristics and stacked in a thickness direction. The material of a layer of the cleaning blade that is at a cleaning edge contacting the member to be cleaned is a high-hardness urethane resin, and the rebound resilience of the high-hardness urethane resin in a low-temperature environment (10° C.) is 25% or less.

Japanese Laid Open Patent Application Publication No. 11-194542 discloses a toner for electrophotography containing a binder resin and a coloring agent. The binder resin used is a resin in which a minimum value of tan δ of the binding resin is present between its glass transition temperature (Tg) and the temperature at which the loss modulus (G″) is 1×10⁴ Pa, and the minimum value of tan δ is less than 1.2. The storage modulus (G′) at the temperature at which tan δ is minimum is 5×10⁵ Pa or more, and the value of tan δ at the temperature at which G″=1×10⁴ Pa is 3.0 or more.

### SUMMARY

One technique for improving the cleanability of the surface of an image holding member is to use a cleaning blade having a high-hardness contact portion contacting the image holding member.

However, when only the cleaning blade having the high-hardness contact portion contacting the image holding member is used, the cleanability of the surface of the image holding member may not be good in a high-temperature high-humidity environment or a low-temperature low-humidity environment, depending on the physical properties (such as viscoelasticity) of the toner.

Aspects of non-limiting embodiments of the present disclosure relate to an image forming apparatus with which the cleanability of the surface of the image holding member in both a high-temperature high-humidity environment and a low-temperature low-humidity environment is better than with an image forming apparatus including a developing unit that houses an electrostatic image developer containing a toner in which (ln η(T1)−ln η(T2))/(T1−T2) is more than −0.14, a toner in which (ln η(T2)−ln η(T3))/(T2−T3) is less than −0.15, or a toner in which the value of (ln η(T1)−ln η(T2))/(T1−T2) is more than the value of (ln η(T2)−ln η(T3))/(T2−T3), wherein η(T1) is the viscosity η of the toner at T1=60° C., η(T2) is the viscosity η of the toner at T2=90° C., and η(T3) is the viscosity η of the toner at T3=130° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including:

an image holding member;

a charging unit that charges a surface of the image holding member;

an electrostatic image forming unit that forms an electrostatic image on the charged surface of the image holding member;

a developing unit that houses a toner for electrostatic image development and develops the electrostatic image formed on the surface of the image holding member with the toner to thereby form a toner image;

a transfer unit that transfers the toner image formed on the surface of the image holding member onto a surface of a recording medium;

a cleaning unit that includes a cleaning blade and cleans the surface of the image holding member; and

a fixing unit that fixes the toner image transferred onto the surface of the recording medium,

wherein the cleaning blade has a contact portion that contacts the surface of the image holding member, the contact portion having a JIS-A hardness of from 90° to 130° inclusive, and

wherein the toner satisfies the following formulas:

(ln η(T1)−ln η(T2))/(T1−T2)≤−0.14;

(ln η(T2)−ln η(T3))/(T2−T3)≥−0.15; and

(ln η(T1)−ln η(T2))/(T1−T2)<(ln η(T2)−ln η(T3))/(T2−T3),

wherein η(T1) is the viscosity of the toner at 60° C., η(T2) is the viscosity of the toner at 90° C., and η(T3) is the viscosity of the toner at 130° C.

### BRIEF DESCRIPTION OF THE DRAWINGS

An exemplary embodiment of the present disclosure will be described in detail based on the following figures, wherein:

FIG. 1 is a schematic configuration diagram showing an example of an image forming apparatus according to an exemplary embodiment;

FIG. 2 is a schematic configuration diagram showing an example of a cleaning unit in the exemplary embodiment; and

FIG. 3 is a schematic configuration diagram showing another example of the cleaning unit in the exemplary embodiment.

### DETAILED DESCRIPTION

In an exemplary embodiment of the disclosure, when reference is made to the amount of a component in a composition, if the composition contains a plurality of materials corresponding to the above component, the above amount means the total amount of the plurality of materials, unless otherwise specified.

In the exemplary embodiment of the disclosure, an “electrostatic image developer” may be referred to simply as a “developer.”

The exemplary embodiment of the present disclosure will be described.

### <Image Forming Apparatus>

An image forming apparatus according to the exemplary embodiment includes: an image holding member; a charging unit that charges a surface of the image holding member; an electrostatic image forming unit that forms an electrostatic image on the charged surface of the image holding member; a developing unit that houses an electrostatic image developer containing a toner and develops the electrostatic image formed on the surface of the image holding member with the electrostatic image developer to thereby form a toner image; a transfer unit that transfers the toner image formed on the surface of the image holding member onto a surface of a recording medium; a cleaning unit that includes a cleaning blade contacting the surface of the image holding member and cleans the surface of the image holding member; and a fixing unit that fixes the toner image transferred onto the surface of the recording medium.

The cleaning blade of the cleaning unit has a contact portion contacting the surface of the image holding member, the contact portion having a JIS-A hardness of from 90° to 130° inclusive.

The developer housed in the developing unit contains a toner in which (ln η(T1)−ln η(T2))/(T1−T2) is −0.14 or less, in which (ln η(T2)−ln η(T3))/(T2−T3) is −0.15 or more, and in which (ln η(T2)−ln η(T3))/(T2−T3) is larger than (ln η(T1)−ln η(T2))/(T1−T2), wherein η(T1) is the viscosity η of the toner at 60° C., η(T2) is the viscosity η of the toner at 90° C., and η(T3) is the viscosity η of the toner at 130° C.

The cleaning blade having the above-described specific JIS-A hardness may be referred to also as a “specific cleaning blade,” and the toner having the above-described characteristics is referred to also as a “specific toner.”

With the image forming apparatus according to the present exemplary embodiment, the cleanability of the surface of the image holding member is good in both a high-temperature high-humidity environment and a low-temperature low-humidity environment.

The reason for this may be as follows.

First, the characteristics of the specific toner will be described. The above formula (ln η(T1)−ln η(T2))/(T1−T2) is an indicator of the degree of change in the viscosity of the toner in the temperature range of 60° C. to 90° C. An indicator value of −0.14 or less means that the change in the viscosity of the toner in the range of 60° C. to 90° C. is large. The formula (ln η(T2)−ln η(T3))/(T2−T3) is an indicator of the degree of change in the viscosity of the toner in the temperature range of 90° C. to 120° C. When this value is −0.15 or more and the value of (ln η(T2)−ln η(T3))/(T2−T3) is larger than the value of (ln η(T1)−ln η(T2))/(T1−T2), the degree of change in the viscosity of the toner in the range of 90° C. to 120° C. is small. Specifically, in the specific toner, the change in viscosity in the temperature range of 60° C. to 90° C. is steep, and the change in viscosity in the temperature range of 90° C. to 120° C. is small.

In the specific toner having the above-described viscosity change characteristics, it is considered that the binder resin contained in the toner contains a low molecular weight component and a high molecular weight component at an appropriate ratio. This may be because of the following reason. When the binder resin contains the low molecular weight component, the viscosity in the range of 60° C. to 90° C. tends to change easily. When the binder resin contains the high molecular weight component, the viscosity in the high temperature range of 90° C. to 120° C. tends not to change easily.

In the specific toner having the above-described viscosity change characteristics, the change in viscosity in the temperature range of from room temperature (e.g., 20° C.) to 60° C. is small, and the specific toner may have appropriate viscoelasticity. Specifically, in the specific toner, the binder resin contains the low molecular weight component and the high molecular weight component at an appropriate ratio. The viscosity of the binder resin is unlikely to change at a temperature of 60° C. or lower, and its viscoelasticity is maintained in an appropriate range.

In the image forming apparatus, after a toner image is transferred from the image holding member onto a surface of a recording medium, the cleaning blade is brought into contact with the surface of the image holding member to remove the toner remaining on the surface of the image holding member (this toner may be hereinafter referred to also as “residual toner”). In one known technique for improving the cleanability of the surface of the image holding member, a cleaning blade having a high-hardness contact member that contacts the image holding member is used to improve the scraping ability of the cleaning blade.

However, when only the above-described cleaning blade with improved scraping ability is used, sufficient cleanability may not be obtained depending on an image forming environment such as a high-temperature high-humidity environment or a low-temperature low-humidity environment.

Specifically, when a toner with low viscoelasticity (a soft toner) is used to form an image in a high-temperature high-humidity environment (for example, at 28° C. and 85% RH), the residual toner on the surface of the image holding member etc. is softened. In this case, when the cleaning blade having the high-hardness contact portion contacts the residual toner, a pressure is further applied from the high-hardness contact portion to the residual toner, and the adhesion of the residual toner increases, so the residual toner adheres to the cleaning blade. When the residual toner adheres to the cleaning blade, the adhered toner is elongated between the adhering portion and the surface of the image holding member, and the elongated toner adheres to the surface of the image holding member. In this case, image defects may occur due to insufficient cleaning of the surface of the image holding member.

When the surface of the image holding member is cleaned, the residual toner is accumulated at the contact between the cleaning blade and the image holding member to form a toner dam. The residual toner is accumulated and cohered in the toner dam and thereby prevented from passing through the gap between the image holding member and the cleaning blade. When an image is formed using a toner with high viscoelasticity (a hard toner) in a low-temperature low-humidity environment (for example, at 10° C. and 15% RH), the cohesiveness between toner particles is low, and an appropriate toner dam is not easily formed at the contact between the cleaning blade and the image holding member. Therefore, the residual toner passes below the cleaning blade and remains on the surface of the image holding member, causing image defects.

The image forming apparatus according to the present exemplary embodiment includes: the cleaning unit including the cleaning blade having the contact portion that contacts the image holding member and has a JIS-A hardness of from 90° to 130° inclusive; and the developing unit that houses the developer containing the above-described specific toner (i.e., the toner with appropriate viscoelasticity).

Since the specific toner has the appropriate viscoelasticity described above, it remains on the surface of the image holding member. Even when the contact between the toner and the image holding member contacts the high-hardness cleaning blade, adhering of the toner to the surface of the image holding member in a high-temperature high-humidity environment is easily prevented, and the passage of the toner below the cleaning blade in a low-temperature low-humidity environment is easily prevented.

This may be the reason that the image forming apparatus according to the present exemplary embodiment has a high ability to clean the surface of the image holding member in both a high-temperature high-humidity environment and a low-temperature low-humidity environment.

With the specific toner having the above-described viscosity change characteristics, the viscosity of the surface of the toner on a fixing member side in a fixing unit is high. In this case, the toner image is easily separated from the fixing member. Moreover, the toner interface on the recording medium side easily melts, so that the toner may easily penetrate into the recording medium sufficiently.

Therefore, in the image forming apparatus according to the present exemplary embodiment, the occurrence of image defects due to insufficient cleaning of the image holding member is prevented in both a high-temperature high-humidity environment and a low-temperature low-humidity environment.

The image forming apparatus according to the present exemplary embodiment may be any of various well-known image forming apparatuses such as: a direct transfer-type image forming apparatus in which a toner image formed on the surface of the image holding member is transferred directly to a recording medium; an intermediate transfer-type image forming apparatus in which a toner image formed on the surface of the image holding member is first-transferred onto the surface of an intermediate transfer body and the toner image transferred onto the surface of the intermediate transfer body is second-transferred onto a surface of a recording medium; and an image forming apparatus including a charge eliminating unit that eliminates charges by irradiating the surface of the image holding member with charge elimination light after transfer of the toner image but before charging.

In the intermediate transfer-type image forming apparatus, the transfer unit includes, for example: an intermediate transfer body having a surface onto which a toner image is to be transferred; a first transfer unit that first-transfers the toner image formed on the surface of the image holding member onto a surface of the intermediate transfer body; and a second transfer unit that second-transfers the toner image transferred onto the surface of the intermediate transfer body onto a surface of a recording medium.

In the image forming apparatus according to the present exemplary embodiment, a section including the developing unit may have a cartridge structure (a process cartridge) detachably attached to the image forming apparatus.

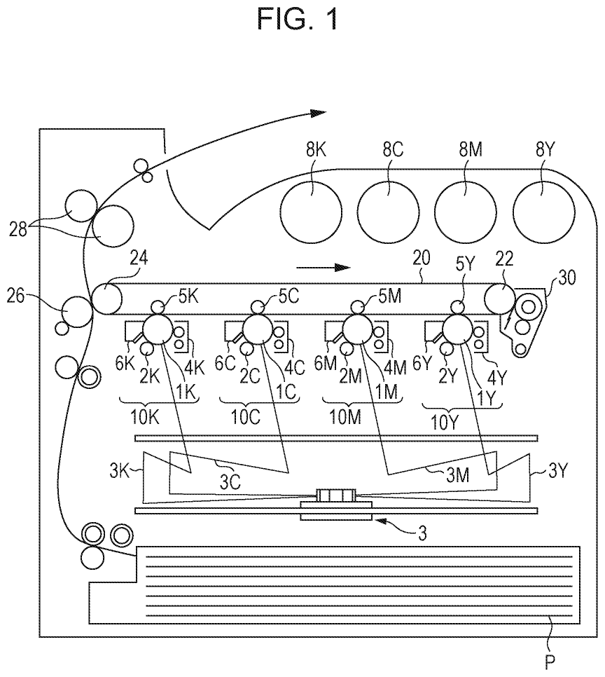

An example of the image forming apparatus in the present exemplary embodiment will be described with reference to the drawings, but the example is not a limitation. In the following description, major components shown in FIG. 1 will be described, and description of other components will be omitted.

FIG. 1 is a schematic configuration diagram showing the image forming apparatus according to the present exemplary embodiment.

The image forming apparatus shown in FIG. 1 includes first to fourth electrophotographic image forming units 10Y, 10M, 10C, and 10K that output yellow (Y), magenta (M), cyan (C), and black (K) images, respectively, based on color-separated image data. These image forming units (hereinafter may be referred to simply as “units”) 10Y, 10M, 10C, and 10K are arranged so as to be spaced apart from each other horizontally by a prescribed distance. These units 10Y, 10M, 10C, and 10K may each be a process cartridge detachable from the image forming apparatus.

An intermediate transfer belt (an example of the intermediate transfer body) 20 is disposed above the units 10Y, 10M, 10C, and 10K so as to extend through these units. The intermediate transfer belt 20 is wound around a driving roller 22 and a support roller 24 that are in contact with the inner surface of the intermediate transfer belt 20 and runs in a direction from the first unit 10Y toward the fourth unit 10K. A force is applied to the support roller 24 by, for example, an unillustrated spring in a direction away from the driving roller 22, so that a tension is applied to the intermediate transfer belt 20 wound around the rollers. An intermediate transfer belt cleaner 30 is disposed on the image holding side of the intermediate transfer belt 20 so as to be opposed to the driving roller 22. A second transfer roller (an example of the second transfer unit) 26 is disposed on the image holding side of the intermediate transfer belt 20 so as to be opposed to the support roller 24.

Developers containing toners are housed in developing devices (examples of the developing unit) 4Y, 4M, 4C, and 4K of the units 10Y, 10M, 10C, and 10K. Yellow, magenta, cyan, and black toners contained in toner cartridges 8Y, 8M, 8C, and 8K, respectively, are supplied to the respective developing devices 4Y, 4M, 4C, and 4K.

In the image forming apparatus according to the present exemplary embodiment, at least one of the toners contained in the developing devices 4Y, 4M, 4C, and 4K is a specific toner. From the viewpoint of improving the cleanability of the surface of the image holding member, all the toners may be specific toners.

The specific toners and the developing units that house the developers containing the specific toners will be described later in detail.

In the image forming apparatus shown in FIG. 1, the charge polarity of each tone is negative (−).

The first to fourth units 10Y, 10M, 10C, and 10K have the same structure and operate similarly. Therefore, the first unit 10Y that is disposed upstream in the running direction of the intermediate transfer belt and forms a yellow image will be described as a representative unit.

In the image forming apparatus according to the present exemplary embodiment, photoconductor cleaning devices 6Y, 6M, 6C, and 6K included in the first to fourth units 10Y, 10M, 10C, and 10K, respectively, are cleaning units including specific cleaning blades. From the viewpoint of improving the cleanability of the surface of the image holding member, each of the photoconductor cleaning devices 6Y, 6M, 6C, and 6K may be a cleaning unit including a specific cleaning blade.

The cleaning unit including the specific cleaning blade will be described later in detail.

The first unit 10Y includes a photoconductor 1Y, which is an example of the image holding member.

A charging roller (an example of the charging unit) 2Y, an exposure unit (an example of the electrostatic image forming unit) 3, a developing device (an example of the developing unit) 4Y, a first transfer roller (an example of the first transfer unit) 5Y, and a photoconductor cleaner (an example of the cleaning unit) 6Y are disposed around the photoconductor 1Y in this order. The charging roller 2Y charges the surface of the photoconductor 1Y to a prescribed electric potential, and the exposure unit 3 exposes the charged surface to a laser beam 3Y according to a color-separated image signal to thereby form an electrostatic image. The developing device 4Y supplies a charged toner to the electrostatic image to develop the electrostatic image, and the first transfer roller 5Y transfers the developed toner image onto the intermediate transfer belt 20. The photoconductor cleaner 6Y removes the toner remaining on the surface of the photoconductor 1Y after the first transfer.

The first transfer roller 5Y is disposed on the inner side of the intermediate transfer belt 20 and placed at a position opposed to the photoconductor 1Y.

Bias power sources (not shown) for applying first transfer biases are connected to the respective first transfer rollers 5Y, 5M, 5C, and 5K of the units. The bias power sources are controlled by an unillustrated controller to change the values of transfer biases applied to the respective first transfer rollers.

A yellow image formation operation in the first unit 10Y will be described.

First, before the operation, the surface of the photoconductor 1Y is charged by the charging roller 2Y to an electric potential of −600 V to −800 V.

The photoconductor 1Y is formed by stacking at least a photosensitive layer on a conductive substrate (with a volume resistivity of, for example, 1×10⁻⁶ Ω cm or less at 20° C.). The photosensitive layer normally has a high resistance (the resistance of a general resin) but has the property that, when irradiated with a laser beam, the specific resistance of a portion irradiated with the laser beam is changed. Therefore, the charged surface of the photoconductor 1Y is irradiated with a laser beam 3Y from the exposure unit 3 according to yellow image data sent from the controller. An electrostatic image with a yellow image pattern is thereby formed on the surface of the photoconductor 1Y.

The electrostatic image is an image formed on the surface of the photoconductor 1Y by charging and is a negative latent image formed as follows. The specific resistance of the irradiated portions of the photosensitive layer irradiated with the laser beam 3Y decreases, and this causes charges on the surface of the photoconductor 1Y to flow. However, the charges in portions not irradiated with the laser beam 3Y remain present, and the electrostatic image is thereby formed.

The electrostatic image formed on the photoconductor 1Y rotates to a prescribed developing position as the photoconductor 1Y rotates. Then the electrostatic image on the photoconductor 1Y at the developing position is developed and visualized as a toner image by the developing device 4Y.

An electrostatic image developer containing, for example, at least a yellow toner and a carrier is housed in the developing device 4Y. The yellow toner is agitated in the developing device 4Y and thereby frictionally charged. The charged yellow toner has a charge with the same polarity (negative polarity) as the charge on the photoconductor 1Y and is held on a developer roller. As the surface of the photoconductor 1Y passes through the developing device 4Y, the yellow toner electrostatically adheres to charge-erased latent image portions on the surface of the photoconductor 1Y, and the latent image is thereby developed with the yellow toner. Then the photoconductor 1Y with the yellow toner image formed thereon continues running at a prescribed speed, and the toner image developed on the photoconductor 1Y is transported to a prescribed first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias (i.e., the first transfer bias) applied in this case has a (+) polarity opposite to the (−) charge polarity of the toner and is controlled to, for example, +10 μA in the first unit 10Y by the controller (not shown). The toner remaining on the photoconductor 1Y is removed and collected by the photoconductor cleaner 6Y.

The first transfer biases applied to first transfer rollers 5M, 5C, and 5K of the second unit 10M and subsequent units are controlled in the same manner as in the first unit.

The intermediate transfer belt 20 with the yellow toner image transferred thereon in the first unit 10Y is sequentially transported through the second to fourth units 10M, 10C and 10K, and toner images of respective colors are superimposed and multi-transferred.

Then the intermediate transfer belt 20 with the four color toner images multi-transferred thereon in the first to fourth units reaches a second transfer portion that is composed of the intermediate transfer belt 20, the support roller 24 in contact with the inner surface of the intermediate transfer belt, and the second transfer roller (an example of the second transferring unit) 26 disposed on the image holding surface side of the intermediate transfer belt 20.

A recording paper sheet (an example of the recording medium) P is supplied to a gap (referred to also as a nip portion) between the second transfer roller 26 and the intermediate transfer belt 20 in contact with each other at a prescribed timing through a supply mechanism, and a second transfer bias is applied to the support roller 24. A bias power source (not shown) for applying the second transfer bias is connected to the support roller 24. The bias power source is controlled by the unillustrated controller and outputs the second transfer bias with, for example, the same polarity (−) as the charge polarity (−) of the toner.

The second transfer bias applied to the support roller 24 causes an electrostatic force directed from the intermediate transfer belt 20 toward the recording paper sheet P to act on the toner image, so that the toner image on the intermediate transfer belt 20 is transferred onto the recording paper sheet P.

The recording paper sheet P with the toner image transferred thereon is transported to a press contact portion (nip portion) of a pair of fixing rollers in a fixing device (an example of the fixing unit) 28, and the toner image is fixed onto the recording paper sheet P to thereby form a fixed image. The recording paper sheet P with the color image fixed thereon is transported to an ejection portion, and a series of the color image formation operations is thereby completed.

### [Developing Units]

The developing units in the image forming apparatus according to the present exemplary embodiment house the respective specific toners containing external additives.

Specifically, each developing unit may be a commonly used developing device in which an image is developed with the developer in contact with the image holding member or without contact with the image holding member.

No particular limitation is imposed on the developing device so long as it has the above-described function, and a suitable developing device may be selected according to the intended purpose. Examples of the developing device include a well-known developing device that has the function of causing a one-component or two-component developer to adhere to a photoconductor using a brush or a roller. In particular, a developing device that uses a developing roller with a developer held on its surface may be used.

### [Developers]

Each developer housed in a corresponding developing unit contains at least a specific toner. The developer may be a one-component developer containing only the specific toner or may be a two-component developer containing the specific toner and a carrier.

### (Specific Toner)

The specific toner contains toner particles and an optional external additive.

### (Characteristic Viscosity Values)

In the specific toner:

(ln η(T1)−ln η(T2))/(T1−T2) is −0.14 or less;

(ln η(T2)−ln η(T3))/(T2−T3) is −0.15 or more; and

(ln η(T2)−ln η(T3))/(T2−T3) is larger than (ln η(T1)−ln η(T2))/(T1−T2), wherein η(T1) is the viscosity η of the toner at T1=60° C., η(T2) is the viscosity η of the toner at T2=90° C., and η(T3) is the viscosity η of the toner at T3=130° C.

In the present disclosure, “ln η(T1)” is the natural logarithm of the viscosity η of the toner at T1=60° C.

In the present disclosure, the unit of the viscosity of the toner is Pa·s, unless otherwise specified.

In the present exemplary embodiment, the viscosities of the toner at different temperatures (specifically at 130° C., 90° C., 60° C., and 40° C.) are values measured by the following method.

In the present exemplary embodiment, the viscosities of the toner are measured using a rotary flat plate rheometer (RDA 2RHIOS system ver. 4.3.2 manufactured by Rheometric Scientific). The viscosities at these temperatures are values measured by placing 0.3 g of a sample between parallel plates having a diameter of 8 mm and heating the sample in the range of about 30° C. to 150° C. at a heating rate of 1° C./min with a distortion of 20% or less applied at a frequency of 1 Hz.

(ln η(T1)−ln η(T2))/(T1−T2), which is one of the characteristic values of the specific toner, is −0.14 or less. From the viewpoint of improving the cleanability of the surface of the image holding member, this value is preferably −0.16 or less, more preferably from −0.30 to −0.18 inclusive, and particularly preferably from −0.25 to −0.20 inclusive.

(ln η(T2)−ln η(T3))/(T2−T3), which is one of the characteristic values of the specific toner, is −0.15 or more. From the viewpoint of improving the cleanability of the surface of the image holding member, this value is preferably more than −0.14, more preferably −0.13 or more, still more preferably from −0.12 to −0.03 inclusive, and particularly preferably from −0.11 to −0.05 inclusive.

In the specific toner, (ln η(T2)−ln η(T3))/(T2−T3) is larger than (ln η(T1)−ln η(T2))/(T1−T2). From the viewpoint of improving the cleanability of the surface of the image holding member, the value of {(ln η(T2)−ln η(T3))/(T2−T3)−{(ln η(T1)−ln η(T2))/(T1−T2)} is preferably 0.01 or more, more preferably from 0.05 to 0.5 inclusive, and particularly preferably from 0.08 to 0.2 inclusive.

Let the viscosity η of the specific toner at T0=40° C. be η(T0). Then, from the viewpoint of improving the cleanability of the surface of the image holding member, it is preferable that (ln η(T0)−ln η(T1))/(T0−T1) is −0.12 or more and that (ln η(T0)−ln η(T1))/(T0−T1) is larger than (ln η(T1)−ln η(T2))/(T1−T2).

When (ln η(T0)−ln η(T1))/(T0−T1) in the specific toner is −0.12 or more, the cleanability of the surface of the image holding member is improved. (ln η(T0)−ln η(T1))/(T0−T1) is more preferably −0.05 or less and particularly preferably from −0.11 to −0.06 inclusive.

In the specific toner, when (ln η(T0)−ln η(T1))/(T0−T1) is larger than (ln η(T1)−ln η(T2))/(T1−T2), the cleanability of the surface of the image holding member is improved. The value of {(ln η(T0)−ln η(T1))/(T0−T1)}−{(ln η(T1)−ln η(T2))/(T1−T2)} is preferably 0.01 or more, more preferably from 0.05 to 0.5 inclusive, and particularly preferably from 0.08 to 0.2 inclusive.

No particular limitation is imposed on the method for controlling the characteristic values of the viscosity at the above temperatures, i.e., (ln η(T1)−ln η(T2))/(T1−T2), (ln η(T2)−ln η(T3))/(T2−T3), and (ln η(T0)−ln η(T1))/(T0−T1), within the above ranges.

Specific examples of the method include a method in which the molecular weight of the binder resin contained in the toner particles is controlled. More particularly, the molecular weights of a low molecular weight component and a high molecular weight component in the binder resin and their contents are controlled. When an aggregation/coalescence method described later is used to produce the toner particles, the degree of aggregation may be controlled, for example, by changing the amount of a flocculant added to control the characteristic values of the viscosity.

In the specific toner, from the viewpoint of improving the cleanability of the surface of the image holding member, the viscosity η(T0) of the toner at T0=40° C., the viscosity η(T1) of the toner at T1=60° C., the viscosity (T2) of the toner at T2=90° C., and the viscosity η(T3) of the toner at T3=130° C. are preferably within the following ranges.

η(T0: from 1.0×10⁷ to 1.0×10⁹ inclusive (more preferably from 2.0×10⁷ to 5.0×10⁸ inclusive)

η(T1): from 1.0×10⁵ to 1.0×10⁸ inclusive (more preferably from 1.0×10⁶ to 5.0×10⁷ inclusive)

η(T2): from 1.0×10³ to 1.0×10⁵ inclusive (more preferably from 5.0×10³ to 5.0×10⁴ inclusive)

η(T3): from 1.0×10² to 1.0×10⁴ inclusive (more preferably from 1.0×10² to 5.0×10³ inclusive)

### (Maximum Endothermic Peak Temperature)

From the viewpoint of ease of controlling the viscosity of the specific toner, improving the cleanability of the surface of the image holding member, and improving the fixability of the toner, the maximum endothermic peak temperature of the specific toner is preferably from 70° C. to 100° C. inclusive, more preferably from 75° C. to 95° C. inclusive, and particularly preferably from 83° C. to 93° C. inclusive.

The maximum endothermic peak temperature of the specific toner is the temperature giving the maximum endothermic peak in an endothermic curve in the range of at least −30° C. to 150° C. in differential scanning calorimetry.

A method for measuring the maximum endothermic peak temperature of the specific toner is shown below.

A differential scanning calorimeter DSC-7 manufactured by PerkinElmer Co., Ltd. is used. To correct the temperature of a detection unit of the device, the melting points of indium and zinc are used. To correct the amount of heat, the heat of fusion of indium is used. An aluminum-made pan is used for a sample, and an empty pan is used for a control. The sample is heated from room temperature to 150° C. at a heating rate of 10° C./min, cooled from 150° C. to −30° C. at a rate of 10° C./min, and heated from −30° C. to 150° C. at a rate of 10° C./min. The temperature at the largest endothermic peak during the second heating is used as the maximum endothermic peak temperature.

### (Infrared Absorption Spectrum of Toner Particles)

The specific toner may contain, as the binder resin, an amorphous polyester resin described later. In this case, from the viewpoint of ease of controlling the viscosity of the toner and improving the cleanability of the surface of the image holding member, it is preferable that the ratio of the absorbance of the toner particles at a wavenumber of 1,500 cm⁻¹ in infrared absorption spectrum analysis to the absorbance at a wavenumber of 720 cm⁻¹ (the absorbance at a wavenumber of 1,500 cm⁻¹/the absorbance at a wavenumber of 720 cm⁻¹) is 0.6 or less and that the ratio of the absorbance at a wavenumber of 820 cm⁻¹ to the absorbance at a wavenumber of 720 cm⁻¹ (the absorbance at a wavenumber of 820 cm⁻¹/the absorbance at a wavenumber of 720 cm⁻¹) is 0.4 or less. It is more preferable that the ratio of the absorbance of the toner particles at a wavenumber of 1,500 cm⁻¹ in infrared absorption spectrum analysis to the absorbance at a wavenumber of 720 cm⁻¹ is 0.4 or less and that the ratio of the absorbance at a wavenumber of 820 cm⁻¹ to the absorbance at a wavenumber of 720 cm¹ is 0.2 or less. It is particularly preferable that the ratio of the absorbance of the toner particles at a wavenumber of 1,500 cm⁻¹ in infrared absorption spectrum analysis to the absorbance at a wavenumber of 720 cm⁻¹ is from 0.2 to 0.4 inclusive and that the ratio of the absorbance at a wavenumber of 820 cm⁻¹ to the absorbance at a wavenumber of 720 cm⁻¹ is from 0.05 to 0.2 inclusive.

The absorbances at the above wavenumbers in the infrared absorption spectrum analysis in the present exemplary embodiment are measured by the following method.

First, toner particles used for the measurement (toner particles with the external additive optionally removed from the toner) are used to prepare a measurement sample by a KBr pellet method. The measurement sample is subjected tow measurement using an infrared spectrophotometer (FT-IR-410 manufactured by JASCO Corporation) in the wavenumber range of from 500 cm⁻¹ to 4,000 cm⁻¹ inclusive under the conditions of a number of times of integration of 300 and a resolution of 4 cm⁻¹. Baseline correction is carried out, for example, at an offset portion with no light absorption, and then the absorbances at the above wavelengths are determined.

In the specific toner, the ratio of the absorbance of the toner particles at a wavenumber of 1,500 cm⁻¹ in the infrared absorption spectrum analysis to the absorbance at a wavenumber of 720 cm⁻¹ is preferably 0.6 or less, more preferably 0.4 or less, still more preferably from 0.2 to 0.4 inclusive, and particularly preferably from 0.3 to 0.4 inclusive.

In the specific toner, the ratio of the absorbance of the toner particles at a wavenumber of 820 cm⁻¹ in the infrared absorption spectrum analysis to the absorbance at a wavenumber of 720 cm⁻¹ is preferably 0.4 or less, more preferably 0.2 or less, still more preferably from 0.05 to 0.2 inclusive, and particularly preferably from 0.08 to 0.2 inclusive.

### (Toner Particles)

The toner particles contain, for example, a binder resin and optionally contain a coloring agent, a release agent, and an additional additive. In particular, the toner particles may contain a binder resin and a release agent.

No particular limitation is imposed on the toner particles, and the toner particles may be: particles such as yellow toner particles, magenta toner particles, cyan toner particles, or black toner particles; white toner particles; transparent toner particles; or brilliant toner particles.

### —Binder Resin —

Examples of the binder resin include: vinyl resins composed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene); and vinyl resins composed of copolymers of combinations of two or more of the above monomers.

Other examples of the binder resin include: non-vinyl resins such as epoxy resins, polyester resins, polyurethane resins, polyamide resins, cellulose resins, polyether resins, and modified rosins; mixtures of the non-vinyl resins and the above-described vinyl resins; and graft polymers obtained by polymerizing a vinyl monomer in the presence of any of these resins.

Any of these binder resins may be used alone or in combination of two or more.

In particular, from the viewpoint of ease of controlling the viscosity of the toner and improving the cleanability of the surface of the image holding member, the binder resin contains preferably at least one selected from the group consisting of styrene-acrylic resins and amorphous polyester resins and contains more preferably a styrene-acrylic resin or an amorphous polyester resin. The styrene-acrylic resin or the amorphous polyester resin is contained in an amount of more preferably 50% by mass or more based on the total mass of the binder resin contained in the toner. The styrene-acrylic resin or the amorphous polyester resin is contained in an amount of particularly preferably 80% by mass or more based on the total mass of the binder resin contained in the toner.

From the viewpoint of the strength and storage stability of the toner, it is preferable that the specific toner contains as the binder resin a styrene-acrylic resin.

From the viewpoint of low-temperature fixability, it is preferable that the specific toner contains as the binder resin an amorphous polyester resin.

From the viewpoint of fixability, it is preferable that the amorphous polyester resin is an amorphous polyester resin not containing a bisphenol structure.

### (1) Styrene-Acrylic Resin

The styrene-acrylic resin suitable as the binder resin is a copolymer obtained by copolymerization of at least a styrene-based monomer (a monomer having a styrene skeleton) and a (meth)acrylic-based monomer (a monomer having a (meth)acrylic group, preferably a monomer having a (meth)acryloxy group). The styrene-acrylic resin contains, for example, a copolymer of a styrene-based monomer and the (meth)acrylate monomer.

The acrylic resin portions of the styrene-acrylic resin are partial structures obtained by polymerizing an acrylic-based monomer, a methacrylic monomer, or both of them. The term “(meth)acrylic” refers to either “acrylic” or “methacrylic.”

Specific examples of the styrene-based monomer include styrene, alkyl-substituted styrenes (such as α-methylstyrene, 2-methylstyrene, 3-methylstyrene, 4-methylstyrene, 2-ethylstyrene, 3-ethylstyrene, and 4-ethylstyrene), halogen-substituted styrenes (such as 2-chlorostyrene, 3-chlorostyrene, and 4-chlorostyrene), and vinylnaphthalene. Any of these styrene-based monomers may be used alone or in combination of two or more.

In particular, from the viewpoint of ease of reaction, ease of controlling the reaction, and availability, the styrene-based monomer is preferably styrene.

Specific examples of the (meth)acrylic-based monomer include (meth)acrylic acid and (meth)acrylates. Examples of the (meth)acrylates include alkyl (meth)acrylates (such as methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth) acrylate, n-tetradecyl (meth) acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (such as phenyl (meth)acrylate, biphenyl (meth) acrylate, diphenylethyl (meth) acrylate, t-butylphenyl (meth)acrylate, and terphenyl (meth)acrylate), dimethylaminoethyl (meth) acrylate, diethylaminoethyl (meth)acrylate, methoxyethyl (meth)acrylate, 2-hydroxyethyl (meth)acrylate, β-carboxyethyl (meth)acrylate, and (meth)acrylamide. Any of these (meth)acrylic-based monomers may be used alone or in combination of two or more.

Among these (meth)acrylic-based monomers, (meth)acrylates are preferable. From the viewpoint of fixability, (meth)acrylates having an alkyl group having 2 to 14 carbon atoms (preferably 2 to 10 carbon atoms and more preferably 3 to 8 carbon atoms) are preferable.

In particular, n-butyl (meth)acrylate is preferable, and n-butyl acrylate is particularly preferable.

No particular limitation is imposed on the copolymerization ratio of the styrene-based monomer and the (meth)acrylic-based monomer (mass ratio: styrene-based monomer/(meth)acrylic-based monomer), but the copolymerization ratio may be 85/15 to 70/30.

From the viewpoint of the strength and storage stability of the toner, the styrene-acrylic resin may have a cross-linked structure. Preferred examples of the styrene-acrylic resin having a cross-linked structure include a copolymer of at least a styrene-based monomer, a (meth)acrylic acid-based monomer, and a cross-linkable monomer.

Examples of the cross-linkable monomer include bifunctional and higher functional cross-linking agents.

Examples of the bifunctional cross-linking agents include divinylbenzene, divinylnaphthalene, di(meth)acrylate compounds (such as diethylene glycol di(meth)acrylate, methylenebis(meth)acrylamide, decanediol diacrylate, and glycidyl (meth)acrylate), polyester-type di(meth)acrylate, and 2-([1′-methylpropylideneamino]carboxyamino)ethyl methacrylate.

Examples of the polyfunctional cross-linking agent include tri(meth)acrylate compounds (such as pentaerythritol tri(meth)acrylate, trimethylolethane tri(meth)acrylate, and trimethylolpropane tri(meth)acrylate), tetra(meth)acrylate compounds (such as pentaerythritol tetra(meth)acrylate and oligoester (meth)acrylate), 2,2-bis(4-methacryloxy, polyethoxyphenyl)propane, diallyl phthalate, triallyl cyanurate, triallyl isocyanurate, triallyl trimellitate, and diallyl chlorendate.

From the viewpoint of the strength, storage stability, and fixability of the toner, the cross-linkable monomer is preferably a bifunctional or higher functional (meth)acrylate compound, more preferably a bifunctional (meth)acrylate compound, still more preferably a bifunctional (meth)acrylate compound having an alkylene group having 6 to 20 carbon atoms, and particularly preferably a bifunctional (meth)acrylate compound having a linear alkylene group having 6 to 20 carbon atoms.

No particular limitation is imposed on the copolymerization ratio of the cross-linkable monomer to the total mass of the monomers (mass ratio: cross-linkable monomer/all the monomers), but the copolymerization ratio may be 2/1,000 to 20/1,000.

From the viewpoint of fixability, the glass transition temperature (Tg) of the styrene-acrylic resin is preferably from 40° C. to 75° C. inclusive and more preferably from 50° C. to 65° C. inclusive.

The glass transition temperature is determined using a DSC curve obtained by differential scanning calorimetry (DSC). More specifically, the glass transition temperature is determined from “extrapolated glass transition onset temperature” described in glass transition temperature determination methods in “Testing methods for transition temperatures of plastics” in JIS K7121-1987.

From the viewpoint of storage stability, the weight average molecular weight of the styrene-acrylic resin is preferably from 5,000 to 200,000 inclusive, more preferably from 10,000 to 100,000 inclusive, and particularly preferably from 20,000 to 80,000 inclusive.

No particular limitation is imposed on the method for producing the styrene-acrylic resin, and any of various polymerization methods (such as solution polymerization, precipitation polymerization, suspension polymerization, bulk polymerization, and emulsion polymerization) may be used. A well-known procedure (such as a batch procedure, a semi-continuous procedure, or a continuous procedure) may be used for the polymerization reaction.

### (2) Polyester Resin

Suitable examples of the polyester resin used as the binder resin include well-known amorphous polyester resins. The polyester resin used may be a combination of an amorphous polyester resin and a crystalline polyester resin. The amount of the crystalline polyester resin used may be from 2% by mass to 40% by mass inclusive (preferably from 2% by mass to 20% by mass inclusive) based on the total mass of the binder resin.

The “crystalline” resin means that, in differential scanning calorimetry (DSC), a clear endothermic peak is observed instead of a stepwise change in the amount of heat absorbed. Specifically, the half width of the endothermic peak when the measurement is performed at a heating rate of 10 (° C./min) is 10° C. or less.

The “amorphous” resin means that the half width exceeds 10° C., that a stepwise change in the amount of heat absorbed is observed, or that a clear endothermic peak is not observed.

### Amorphous Polyester Resin

The amorphous polyester resin may be, for example, a polycondensation product of a polycarboxylic acid and a polyhydric alcohol. The amorphous polyester resin used may be a commercial product or a synthesized product.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides thereof, and lower alkyl (e.g., having 1 to 5 carbon atoms) esters thereof. In particular, the polycarboxylic acid is, for example, preferably an aromatic dicarboxylic acid.

The polycarboxylic acid used may be a combination of a dicarboxylic acid and a tricarboxylic or higher polycarboxylic acid having a crosslinked or branched structure. Examples of the tricarboxylic or higher polycarboxylic acid include trimellitic acid, pyromellitic acid, anhydrides thereof, and lower alkyl (e.g., having 1 to 5 carbon atoms) esters thereof.

Any of these polycarboxylic acids may be used alone or in combination of two or more.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as an ethylene oxide adduct of bisphenol A and a propylene oxide adduct of bisphenol A). In particular, the polyhydric alcohol is, for example, preferably an aromatic diol or an alicyclic diol and more preferably an aromatic diol.

The polyhydric alcohol used may be a combination of a diol and a trihydric or higher polyhydric alcohol having a crosslinked or branched structure. Examples of the trihydric or higher polyhydric alcohol include glycerin, trimethylolpropane, and pentaerythritol.

Any of these polyhydric alcohols may be used alone or in combination or two or more.

The glass transition temperature (Tg) of the amorphous polyester resin is preferably from 50° C. to 80° C. inclusive and more preferably from 50° C. to 65° C. inclusive.

The glass transition temperature is determined from a DSC curve obtained by differential scanning calorimetry (DSC). More specifically, the glass transition temperature is determined from “extrapolated glass transition onset temperature” described in glass transition temperature determination methods in “Testing methods for transition temperatures of plastics” in JIS K7121-1987.

The weight average molecular weight (Mw) of the amorphous polyester resin is preferably from 5,000 to 1,000,000 inclusive and more preferably from 7,000 to 500,000 inclusive.

The number average molecular weight (Mn) of the amorphous polyester resin may be from 2,000 to 100,000 inclusive.

The molecular weight distribution Mw/Mn of the amorphous polyester resin is preferably from 1.5 to 100 inclusive and more preferably from 2 to 60 inclusive.

The weight average molecular weight and the number average molecular weight are measured by gel permeation chromatography (GPC). In the molecular weight distribution measurement by GPC, a GPC measurement apparatus HLC-8120GPC manufactured by TOSOH Corporation is used, and a TSKgel Super HM-M (15 cm) column manufactured by TOSOH Corporation and a THF solvent are used. The weight average molecular weight and the number average molecular weight are computed from the measurement results using a molecular weight calibration curve produced using monodispersed polystyrene standard samples.

The amorphous polyester resin can be obtained by a well-known production method. For example, in one production method, the polymerization temperature is set to from 180° C. to 230° C. inclusive. If necessary, the pressure of the reaction system is reduced, and the reaction is allowed to proceed while water and alcohol generated during condensation are removed.

When raw material monomers are not dissolved or not compatible with each other at the reaction temperature, a high-boiling point solvent serving as a solubilizer may be added to dissolve the monomers. In this case, the polycondensation reaction is performed while the solubilizer is removed by evaporation. When a monomer with poor compatibility is present in the copolymerization reaction, the monomer with poor compatibility and an acid or an alcohol to be polycondensed with the monomer are condensed in advance and then the resulting polycondensation product and the rest of the components are subjected to polycondensation.

### Crystalline Polyester Resin

The crystalline polyester resin is, for example, a polycondensation product of a polycarboxylic acid and a polyhydric alcohol. The crystalline polyester resin used may be a commercial product or a synthesized product.

The crystalline polyester resin is preferably a polycondensation product using a polymerizable monomer having a linear aliphatic group rather than using a polymerizable monomer having an aromatic group, in order to facilitate the formation of a crystalline structure.

Examples of the polycarboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides thereof, and lower alkyl (e.g., having 1 to 5 carbon atoms) esters thereof.

The polycarboxylic acid used may be a combination of a dicarboxylic acid and a tricarboxylic or higher polycarboxylic acid having a crosslinked or branched structure. Examples of the tricarboxylic acid include aromatic carboxylic acids (such as 1,2,3-benzenetricarboxylic acid, 1,2,4-benzenetricarboxylic acid, and 1,2,4-naphthalene tricarboxylic acid), anhydrides thereof, and lower alkyl (e.g., having 1 to 5 carbon atoms) esters thereof.

The polycarboxylic acid used may be a combination of a dicarboxylic acid, a dicarboxylic acid having a sulfonic acid group, and a dicarboxylic acid having an ethylenic double bond.

Any of these polycarboxylic acids may be used alone or in combination of two or more.

The polyhydric alcohol may be, for example, an aliphatic diol (e.g., a linear aliphatic diol with a main chain having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. In particular, the aliphatic diol is preferably 1,8-octanediol, 1,9-nonanediol, or 1,10-decanediol.

The polyhydric alcohol used may be a combination of a diol and a trihydric or higher polyhydric alcohol having a crosslinked or branched structure. Examples of the trihydric or higher polyhydric alcohol include glycerin, trimethylolethane, trimethylolpropane, and pentaerythritol.

Any of these polyhydric alcohols may be used alone or in combination of two or more.

In the polyhydric alcohol, the content of the aliphatic diol may be 80% by mole or more and preferably 90% by mole or more.

The melting temperature of the crystalline polyester resin is preferably from 50° C. to 100° C. inclusive, more preferably from 55° C. to 90° C. inclusive, and still more preferably from 60° C. to 85° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The weight average molecular weight (Mw) of the crystalline polyester resin may be from 6,000 to 35,000 inclusive.

Like the amorphous polyester resin, the crystalline polyester resin is obtained by a well-known production method.

The content of the binder resin is, for example, preferably from 40% by mass to 95% by mass inclusive, more preferably from 50% by mass to 90% by mass inclusive, and still more preferably from 60% by mass to 85% by mass inclusive based on the total mass of the toner particles.

When the toner particles are white toner particles, the content of the binder resin is preferably from 30% by mass to 85% by mass inclusive and more preferably from 40% by mass to 60% by mass inclusive based on the total mass of the white toner particles.

### —Coloring Agent—

Examples of the coloring agent include: various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, malachite green oxalate, titanium oxide, zinc oxide, calcium carbonate, basic lead carbonate, a mixture of zinc sulfide and barium sulfate, zinc sulfide, silicon dioxide, and aluminum oxide; and various dyes such as acridine-based dyes, xanthene-based dyes, azo-based dyes, benzoquinone-based dyes, azine-based dyes, anthraquinone-based dyes, thioindigo-based dyes, dioxazine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes.

When the toner particles are white toner particles, the coloring agent used may be a white pigment.

The white pigment is preferably titanium oxide or zinc oxide and more preferably titanium oxide.

Any of these coloring agents may be used alone or in combination of two or more.

The coloring agent used may be optionally subjected to surface treatment or may be used in combination with a dispersant. A plurality of coloring agents may be used in combination.

The content of the coloring agent is, for example, preferably from 1% by mass to 30% by mass inclusive and more preferably from 3% by mass to 15% by mass inclusive based on the total mass of the toner particles.

When the toner particles are white toner particles, the content of the white pigment is preferably from 15% by mass to 70% by mass inclusive and more preferably from 20% by mass to 60% by mass inclusive based on the total mass of the white toner particles.

### —Release Agent—

Examples of the release agent include: hydrocarbon-based waxes; natural waxes such as carnauba wax, rice wax, and candelilla wax; synthetic and mineral/petroleum-based waxes such as montan wax; and ester-based waxes such as fatty acid esters and montanic acid esters. However, the release agent is not limited to these waxes.

From the viewpoint of obtaining releasability, the melting temperature of the release agent is preferably from 50° C. to 110° C. inclusive, more preferably from 70° C. to 100° C. inclusive, still more preferably from 75° C. to 95° C. inclusive, and particularly preferably from 83° C. to 93° C. inclusive.

The melting temperature of the release agent is determined using a DSC curve obtained by differential scanning calorimetry (DSC) from “peak melting temperature” described in melting temperature determination methods in “Testing methods for transition temperatures of plastics” in JIS K7121-1987.

Let the number of release agent domains with an aspect ratio of 5 or more in the particles of the specific toner be “a,” and the number of release agent domains with an aspect ratio of less than 5 be “b.” Then, from the viewpoint of ease of control of the viscosity of the toner and improving the cleanability of the surface of the image holding member, it is preferable that 1.0<a/b<8.0 holds. It is more preferable that 2.0<a/b<7.0 holds, and it is particularly preferable that 3.0<a/b<6.0 holds.

Let the total cross-sectional area of release agent domains with an aspect ratio of 5 or more in the particles of the specific toner be “c,” and the total cross-sectional area of release agent domains with an aspect ratio of less than 5 be “d.” Then, from the viewpoint of ease of control of the viscosity of the toner and improving the cleanability, it is preferable that 1.0<c/d<4.0 holds. It is more preferable that 1.5<c/d<3.5 holds, and it is particularly preferable that 2.0<c/d<3.0 holds.

The aspect ratio of the release agent in the toner is measured by the following method.

The toner is mixed into an epoxy resin, and the epoxy resin is cured. The cured product obtained is cut using an ultramicrotome (ULTRACUT UCT manufactured by Leica) to produce a thin sample with a thickness of from 80 nm to 130 nm inclusive. The thin sample is stained with ruthenium tetroxide for 3 hours in a desiccator at 30° C. Then an SEM image of the stained thin sample is obtained under an ultra-high-resolution field-emission scanning electron microscope (FE-SEM) (e.g., S-4800 manufactured by Hitachi High-Technologies Corporation). Generally, the release agent is more easily stained with ruthenium tetroxide than the binder resin and is therefore identified by gradation caused by the degree of staining. The difference in gradation may not be clear for some samples. In this case, the time of staining is adjusted. In cross sections of toner particles, coloring agent domains are generally smaller than release agent domains, and they can be distinguished from each other based on their size.

The SEM image contains cross sections of toner particles with different sizes. Cross sections of toner particles with dimeters equal to or larger than 85% of the volume average particle diameter of the toner particles are selected, and the cross sections of 100 toner particles are selected arbitrary from the selected particles and observed. The diameter of the cross section of a toner particle is the maximum length between two points on the outline of the cross section of the toner particle (i.e., the major axis).

In the SEM image, image analysis is performed on each of the cross sections of the selected 100 particles using image analysis software WINROOF (manufactured by MITANI CORPORATION) under the condition of 0.010000 μm/pixel. In the image analysis, the image of the cross sections of the toner particles can be observed based on the difference in brightness (contrast) between the embedding epoxy resin and the binder resin of the toner particles. Using the image observed, the major axis length, minor axis length, aspect ratio (the major axis length/the minor axis length), and cross-sectional area of each of the release agent domains in the toner particles can be determined.

Examples of the method for controlling the aspect ratio of the release agent in the toner include a method in which the release agent is held at a temperature around the freezing point of the release agent for a given time during cooling to grow the crystals of the release agent and a method in which two or more types of release agents with different melting temperatures are used such that crystal growth during cooling is facilitated.

The content of the release agent is, for example, preferably from 1% by mass to 20% by mass inclusive and more preferably from 5% by mass to 15% by mass inclusive based on the total mass of the toner particles.

### —Additional Additives—

Examples of additional additives include well-known additives such as a magnetic material, a charge control agent, and an inorganic powder. These additives are contained in the toner particles as internal additives.

### —Characteristics Etc. of Toner Particles—

The toner particles may have a single layer structure or may be core shell toner particles each having a so-called core shell structure including a core (core particle) and a coating layer (shell layer) covering the core.

The toner particles having the core shell structure may each include, for example: a core containing the binder resin and optional additives such as the coloring agent and the release agent; and a coating layer containing the binder resin.

The volume average particle diameter (D50v) of the toner particles is preferably from 2 μm to 10 μm inclusive and more preferably from 4 μm to 8 μm inclusive.

The volume average particle diameter of the toner particles is measured using COULTER MULTISIZER II (manufactured by Beckman Coulter, Inc.), and ISOTON-II (manufactured by Beckman Coulter, Inc.) is used as an electrolyte.

In the measurement, 0.5 mg to 50 mg of a measurement sample is added to 2 mL of a 5% by mass aqueous solution of a surfactant (preferably sodium alkylbenzenesulfonate) serving as a dispersant. The mixture is added to 100 mL to 150 mL of the electrolyte.

The electrolyte with the sample suspended therein is subjected to dispersion treatment for 1 minute using an ultrasonic dispersion apparatus, and then the particle size distribution of particles having diameters within the range of 2 μm to 60 μm is measured using the COULTER MULTISIZER II with an aperture having an aperture diameter of 100 μm. The number of particles sampled is 50,000.

The particle size distribution measured and divided into particle size ranges (channels) is used to obtain a volumetric cumulative distribution computed from the small diameter side, and the particle diameter at a cumulative frequency of 50% is defined as the volume average particle diameter D50v.

No particular limitation is imposed on the average circularity of the toner particles. However, from the viewpoint of improving the ease of cleaning the toner from an image-holding member, the average circularity is preferably from 0.91 to 0.98 inclusive, more preferably from 0.94 to 0.98 inclusive, and still more preferably from 0.95 to 0.97 inclusive.

The circularity of a toner particle is determined as (the peripheral length of an equivalent circle of the toner particle)/(the peripheral length of the toner particle) (i.e., the peripheral length of a circle having the same area as a projection image of the particle/the peripheral length of the projection image of the particle). Specifically, the average circularity is a value measured by the following method.

First, the toner particles used for the measurement are collected by suction, and a flattened flow of the particles is formed. Particle images are captured as still images using flashes of light, and the average circularity is determined by subjecting the particle images to image analysis using a flow-type particle image analyzer (e.g., FPIA-3000 manufactured by SYSMEX Corporation). The number of sampled particles for determination of the average circularity is 3,500.

When the toner contains the external additive, the toner (developer) for the measurement is dispersed in water containing a surfactant, and the dispersion is subjected to ultrasonic treatment, whereby the toner particles with the external additive removed are obtained.

When the toner particles are produced, for example, by an aggregation/coalescence method, the average circularity of the toner particles can be controlled by adjusting the stirring rate of a dispersion, the temperature of the dispersion, or the retention time in a fusion/coalescence step.

### (External Additive)

Examples of the external additive include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of the inorganic particles used as the external additive may be subjected to hydrophobic treatment. The hydrophobic treatment is performed, for example, by immersing the inorganic particles in a hydrophobic treatment agent. No particular limitation is imposed on the hydrophobic treatment agent, and examples of the hydrophobic treatment agent include silane-based coupling agents, silicone oils, titanate-based coupling agents, and aluminum-based coupling agents. Any of these may be used alone or in combination of two or more.

The amount of the hydrophobic treatment agent is generally, for example, from 1 part by mass to 10 parts by mass inclusive based on 100 parts by mass of the inorganic particles.

Other examples of the external additive include resin particles (particles of resins such as polystyrene, polymethyl methacrylate (PMMA), and melamine resins) and cleaning aids (such as metal salts of higher fatty acids typified by zinc stearate and fluorine-based polymer particles).

The amount of the external additive added externally is, for example, preferably from 0.01% by mass to 10% by mass inclusive and more preferably from 0.01% by mass to 6% by mass inclusive based on the mass of the toner particles.

### (Method for Producing Toner)

Next, a method for producing the specific toner will be described.

The specific toner is obtained by producing toner particles and then externally adding the external additive to the toner particles produced.

The toner particles may be produced by a dry production method (such as a kneading-grinding method) or by a wet production method (such as an aggregation/coalescence method, a suspension polymerization method, or a dissolution/suspension method). No particular limitation is imposed on the toner particle production method, and any known production method may be used.

In particular, the aggregation/coalescence method may be used to obtain the toner particles.

Specifically, when the toner particles are produced, for example, by the aggregation/coalescence method, the toner particles are produced through: the step of preparing a resin particle dispersion in which resin particles used as the binder resin are dispersed (a resin particle dispersion preparing step); the step of aggregating the resin particles (and other optional particles) in the resin particle dispersion (the dispersion may optionally contain an additional particle dispersion mixed therein) to form aggregated particles (an aggregated particle forming step); and the step of heating the aggregated particle dispersion with the aggregated particles dispersed therein to fuse and coalesce the aggregated particles to thereby form the toner particles (a fusion/coalescence step).

These steps will next be described in detail.

In the following, a method for obtaining toner particles containing the coloring agent and the release agent will be described, but the coloring agent and the release agent are used optionally. Of course, additional additives other than the coloring agent and the release agent may be used.

### —Resin Particle Dispersion Preparing Step—

The resin particle dispersion in which the resin particles used as the binder resin are dispersed is prepared, and, for example, a coloring agent particle dispersion in which coloring agent particles are dispersed and a release agent particle dispersion in which release agent particles are dispersed are prepared.

The resin particle dispersion is prepared, for example, by dispersing the resin particles in a dispersion medium using a surfactant.

Examples of the dispersion medium used for the resin particle dispersion include aqueous mediums.

Examples of the aqueous medium include: water such as distilled water and ion exchanged water; and alcohols. Any of these may be used alone or in combination of two or more.

Examples of the surfactant include: anionic surfactants such as sulfate-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene oxide adduct-based surfactants, and polyhydric alcohol-based surfactants. Of these, an anionic surfactant or a cationic surfactant may be used. A nonionic surfactant may be used in combination with the anionic surfactant or the cationic surfactant.

Any of these surfactants may be used alone or in combination of two or more.

To disperse the resin particles in the dispersion medium to form the resin particle dispersion, a commonly used dispersing method that uses, for example, a rotary shearing-type homogenizer, a ball mill using media, a sand mill, or a dyno-mill may be used. The resin particles may be dispersed in the dispersion medium by a phase inversion emulsification method, but this depends on the type of resin particles.

In the phase inversion emulsification method, the resin to be dispersed is dissolved in a hydrophobic organic solvent that can dissolve the resin, and a base is added to an organic continuous phase (O phase) to neutralize it. Then the aqueous medium (W phase) is added to change the form of the resin from W/O to O/W (so-called phase inversion) to thereby form a discontinuous phase, and the resin is thereby dispersed as particles in the aqueous medium.

The volume average particle diameter of the resin particles dispersed in the resin particle dispersion is, for example, preferably from 0.01 μm to 1 μm inclusive, more preferably from 0.08 μm to 0.8 μm inclusive, and still more preferably from 0.1 μm to 0.6 μm inclusive.

The volume average particle diameter of the resin particles is measured as follows. A particle size distribution measured by a laser diffraction particle size measurement apparatus (e.g., LA-700 manufactured by HORIBA Ltd.) is used and divided into different particle diameter ranges (channels), and a cumulative volume distribution computed from the small particle diameter side is determined. The particle diameter at which the cumulative frequency is 50% is measured as the volume average particle diameter D50v. The volume average particle diameters of particles in other dispersions are measured in the same manner.

The content of the resin particles contained in the resin particle dispersion is, for example, preferably from 5% by mass to 50% by mass inclusive and more preferably from 10% by mass to 40% by mass inclusive.

For example, the coloring agent particle dispersion and the release agent particle dispersion are prepared in a similar manner to the resin particle dispersion. Specifically, the descriptions of the volume average particle diameter of the particles in the resin particle dispersion, the dispersion medium for the resin particle dispersion, the dispersing method, and the content of the resin particles are applicable to the coloring agent particles dispersed in the coloring agent particle dispersion and the release agent particles dispersed in the release agent particle dispersion.

### —Aggregated Particle Forming Step—

Next, the resin particle dispersion, the coloring agent particle dispersion, and the release agent particle dispersion are mixed.

Then the resin particles, the coloring agent particles, and the release agent particles are hetero-aggregated in the dispersion mixture to form aggregated particles containing the resin particles, the coloring agent particles, and the release agent particles and having diameters close to the diameters of target toner particles.

Specifically, for example, a flocculant is added to the dispersion mixture, and the pH of the dispersion mixture is adjusted to acidic (for example, a pH of from 2 to 5 inclusive). Then a dispersion stabilizer is optionally added, and the resulting mixture is heated to a temperature close to the glass transition temperature of the resin particles (specifically, for example, a temperature from the glass transition temperature of the resin particles −30° C. to the glass transition temperature −10° C. inclusive) to aggregate the particles dispersed in the dispersion mixture to thereby form aggregated particles.

In the aggregated particle forming step, the flocculant may be added at room temperature (e.g., 25° C.) while the dispersion mixture is agitated, for example, in a rotary shearing-type homogenizer. Then the pH of the dispersion mixture is adjusted to acidic (e.g., a pH of from 2 to 5 inclusive), and the dispersion stabilizer is optionally added. Then the resulting mixture is heated in the manner described above.

Examples of the flocculant include a surfactant with polarity opposite to the polarity of the surfactant added to the dispersion mixture, inorganic metal salts, and divalent or higher polyvalent metal complexes. In particular, when a metal complex is used as the flocculant, the amount of the surfactant used can be reduced, and charging characteristics are improved.

An additive that forms a complex with a metal ion in the flocculant or a similar bond may be optionally used. The additive used may be a chelating agent.

Examples of the inorganic metal salts include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent used may be a water-soluble chelating agent. Examples of the chelating agent include: oxycarboxylic acids such as tartaric acid, citric acid, and gluconic acid; iminodiacetic acid (IDA); nitrilotriacetic acid (NTA); and ethylenediaminetetraacetic acid (EDTA).

The amount of the chelating agent added is, for example, preferably from 0.01 parts by mass to 5.0 parts by mass inclusive and more preferably 0.1 parts by mass or more and less than 3.0 parts by mass based on 100 parts by mass of the resin particles.

### —Fusion/Coalescence Step—

Next, the aggregated particle dispersion in which the aggregated particles are dispersed is heated, for example, to a temperature equal to or higher than the glass transition temperature of the resin particles (e.g., a temperature higher by 10° C. to 30° C. than the glass transition temperature of the resin particles) to fuse and coalesce the aggregated particles to thereby form toner particles.

Alternatively, the aggregated particle dispersion may be heated to a temperature equal to or higher than the melting temperature of the release agent to fuse and coalesce the aggregated particles to thereby form toner particles. In the fusion/coalescence step, the resin and the release agent are compatible with each other at the temperature equal to or higher than the glass transition temperature of the resin particles and equal to or higher than the melting temperature of the release agent. Then the dispersion is cooled to obtain a toner.

Examples of the method for controlling the aspect ratio of the release agent in the toner include a method in which the dispersion is held at a temperature around the freezing point of the release agent for a given time during cooling to grow the crystals of the release agent and a method in which two or more types of release agents with different melting temperatures are used to facilitate crystal growth during cooling.

The toner particles are obtained through the above-described steps.

Alternatively, the toner particles may be produced through: the step of, after the preparation of the aggregated particle dispersion containing the aggregated particles dispersed therein, mixing the aggregated particle dispersion further with the resin particle dispersion containing the resin particles dispersed therein and then causing the resin particles to adhere to the surface of the aggregated particles to aggregate them to thereby form second aggregated particles; and the step of heating a second aggregated particle dispersion containing the second aggregated particles dispersed therein to fuse and coalesce the second aggregated particles to thereby form toner particles having the core shell structure.

After completion of the fusion/coalescence step, the toner particles formed in the solution are subjected to a well-known washing step, a solid-liquid separation step, and a drying step to obtain dried toner particles.

From the viewpoint of chargeability, the toner particles may be subjected to displacement washing with ion exchanged water sufficiently in the washing step. No particular limitation is imposed on the solid-liquid separation step. From the viewpoint of productivity, suction filtration, pressure filtration, etc. may be performed in the solid-liquid separation step. No particular limitation is imposed on the drying step. From the viewpoint of productivity, freeze-drying, flash drying, fluidized drying, vibrating fluidized drying, etc. may be performed in the drying step.

The specific toner is produced, for example, by adding the external additive to the dried toner particles obtained and mixing them. The mixing may be performed, for example, using a V blender, a HENSCHEL mixer, a Loedige mixer, etc. If necessary, coarse particles in the toner may be removed using a vibrating sieving machine, an air sieving machine, etc.

### (Carrier)

No particular limitation is imposed on the carrier, and a well-known carrier may be used.

Examples of the carrier include: a coated carrier prepared by coating the surface of a core material formed of a magnetic powder with a coating resin; a magnetic powder-dispersed carrier prepared by dispersing a magnetic powder in a matrix resin; and a resin-impregnated carrier prepared by impregnating a porous magnetic powder with a resin.

In each of the magnetic powder-dispersed carrier and the resin-impregnated carrier, the particles included in the carrier may be used as cores, and the cores may be coated with a coating resin.

Examples of the magnetic powder include: magnetic metal powders such as iron powder, nickel powder, and cobalt powder; and magnetic oxide powders such as ferrite powder and magnetite powder.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins having organosiloxane bonds and modified products thereof, fluorocarbon resins, polyesters, polycarbonates, phenolic resins, and epoxy resins.

The coating resin and the matrix resin may contain an additional additive such as electrically conductive particles.

Examples of the electrically conductive particles include: particles of metals such as gold, silver, and copper; and particles of carbon black, titanium oxide, zinc oxide, tin oxide, barium sulfate, aluminum borate, and potassium titanate.

To coat the surface of the core material with a coating resin, the surface of the core material may be coated with a coating layer-forming solution prepared by dissolving the coating resin and various optional additives in an appropriate solvent. No particular limitation is imposed on the solvent, and the solvent may be selected in consideration of the type of the resin used, ease of coating, etc.

Specific examples of the resin coating method include: an immersion method in which the core material is immersed in the coating layer-forming solution; a spray method in which the coating layer-forming solution is sprayed onto the surface of the core material; a fluidized bed method in which the coating layer-forming solution is sprayed onto the core material floated by the flow of air; and a kneader-coater method in which the core material and the coating layer-forming solution are mixed in a kneader coater and then the solvent is removed.

The mixing ratio (mass ratio) of the toner and the carrier in the two-component developer is preferably toner:carrier=1:100 to 30:100 and more preferably 3:100 to 20:100.

### [Cleaning Unit]

The cleaning unit in the present exemplary embodiment includes the cleaning blade (i.e., the specific cleaning blade) that contacts the surface of the image holding member and has a contact portion contacting the surface of the image holding member and having a JIS-A hardness of from 90° to 130° inclusive. The cleaning unit cleans the surface of the image holding member.

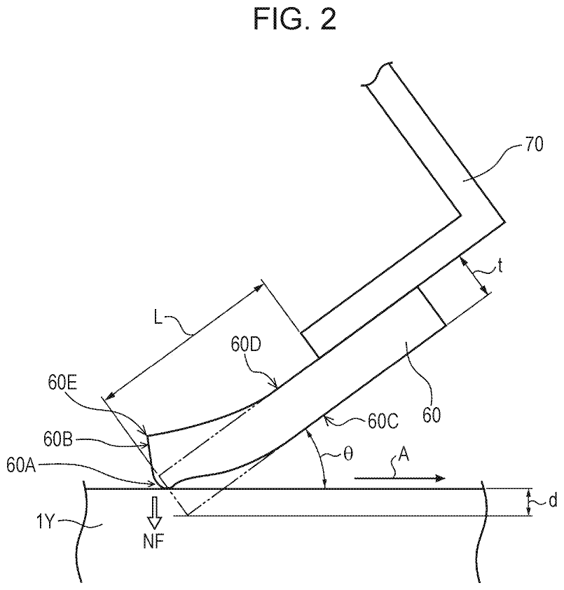

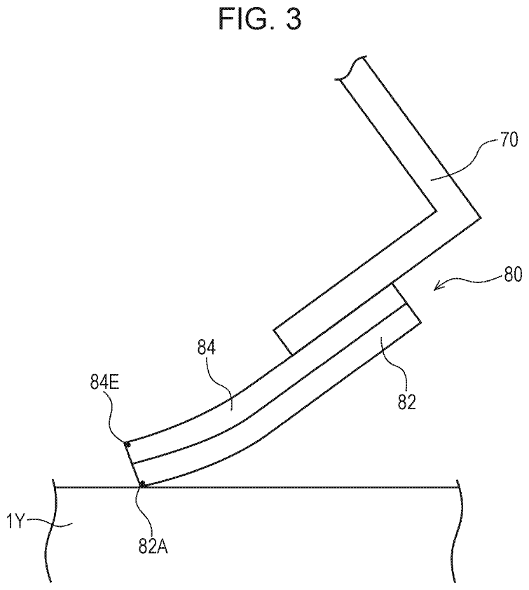

The cleaning unit will be described using FIGS. 2 and 3. FIG. 2 is a schematic configuration diagram showing the structure and installation of the cleaning blade in the photoconductor cleaning device 6Y shown in FIG. 1.

As described above, the first to fourth units 10Y, 10M, 10C, and 10K have the same structure and operate similarly. Therefore, the photoconductor cleaning device 6Y of the first unit 10Y will be described as a representative device.

The photoconductor cleaning device 6Y includes a cleaning blade 60 corresponding to the specific cleaning blade.

As shown in FIG. 2, the cleaning blade 60 includes: a contact portion 60A that contacts the moving photoconductor 1Y to clean the surface of the photoconductor 1Y; a forward end surface 60B on which the contact portion 60A forms one of the edges of the forward end surface 60B and which is directed to the upstream side in the moving direction (the direction of an arrow A) of the photoconductor 1Y; a front surface 60C in which the contact portion 60A forms one of the edges of the front surface 60C and which is oriented to the downstream side in the moving direction (the direction of the arrow A) of the photoconductor 1Y; a back surface 60D that shares one edge with the forward end surface 60B and faces the front surface 60C; and a non-contact corner edge 60E which is a corner edge opposed to the contact portion 60A on the forward end surface 60B side and at which the forward end surface 60B and the back surface 60D are in contact with each other.

In the photoconductor cleaning device 6Y, one edge surface (i.e., the forward end surface 60B) of the cleaning blade 60 is directed opposite to the rotation direction (the direction of the arrow A) of the photoconductor 1Y, and one corner edge of the forward end surface 60B (i.e., the contact portion 60A) is brought into contact with the photoconductor 1Y to remove adhering substances such as a residual toner adhering to the surface of the photoconductor 1Y.

The cleaning blade 60 is joined to a support member 70 at the back surface 60D opposite to the surface in contact with the photoconductor 1Y, i.e., opposite to the forward end surface 60B and is supported by the support member 70.

In FIG. 2, the support member 70 used has an L shape and is made of a metal (e.g., a metal material such as aluminum or stainless steel).

A bonding layer formed of, for example, an adhesive may be present between the support member 70 and the cleaning blade 60 to join them to each other.

An unillustrated pressing member is joined to the support member 70, and the cleaning blade 60 is pressed against the photoconductor 1Y by the pressing member through the support member 70.

### [Pressing of Cleaning Blade]

The cleaning blade 60 is pressed against the photoconductor 1Y. The pressing pressure NF and the contact angle WA during pressing will be described.

### Pressing Pressure NF

From the viewpoint of improving the cleaning performance of the cleaning blade 60, the pressing pressure of the cleaning blade 60 against the photoconductor 1Y (i.e., the pressure acting between the contact portion 60A of the cleaning blade 60 and the surface of the photoconductor 1Y) is preferably from 2.0 gf/mm to 3.2 gf/mm inclusive, more preferably from 2.3 gf/mm to 3.2 gf/mm inclusive, and still more preferably from 2.3 gf/mm to 2.9 gf/mm inclusive.

### Contact Angle WA

From the viewpoint of improving the cleaning performance, the contact angle WA between the cleaning blade 60 and the photoconductor 1Y is preferably from 9° to 12° inclusive, more preferably from 9.5° to 12° inclusive, and still more preferably from 10° to 11.5° inclusive.

The pressing pressure NF of the cleaning blade 60 against the photoconductor 1Y and the contact angle WA therebetween are measured by the following method.

First, a certain displacement is imparted to the cleaning blade 60, and the load is measured by a load cell to determine the intrinsic spring constant k of the cleaning blade 60. Next, the cleaning blade 60 is fixed to the support member 70, and the position of the blade edge (i.e., the angle including the contact portion 60A) is measured. To measure the position, a laser displacement meter, for example, may be used. The amount of displacement d of the cleaning blade 60 from the position of the blade edge when the photoconductor 1Y is brought into contact with the cleaning blade 60 is measured. The above-measured value, the free length L of the cleaning blade 60 (the length of a portion not fixed to the support member 70), and the preset angle θ of the cleaning blade 60 (i.e., the angle between the photoconductor 1Y and a straight portion of the cleaning blade 60 (a portion not distorted when the cleaning blade 60 is pressed against the photoconductor 1Y) at the contact portion) are used to compute the pressing pressure NF and the contact angle WA from the following formulas.

Pressing pressure NF=k×d

Contact angle WA=θ−tan⁻¹(3d/2L)

### [Specific Cleaning Blade]

Next, the specific cleaning blade will be described.

The specific cleaning blade is a plate-shaped member having a contact portion contacting the surface of the image holding member, and the JIS-A hardness of the contact portion is from 90° to 130° inclusive. No limitation is imposed on the other components.

### (JIS-A Hardness)

In the specific cleaning blade, the contact portion (i.e., the contact portion 60A in FIG. 2) contacting the surface of the image holding member has a JIS-A hardness of 90° or more. Therefore, the wear of the cleaning blade is reduced, and a sufficient scraping force acts on the surface of the image holding member. In the specific cleaning blade, since the JIS-A hardness of the contact portion is 130° or less, the surface of the image holding member is unlikely to be scratched, and the formation of flaws on the surface of the image holding member is prevented. Moreover, the wear of the surface of the image holding member is reduced.

The JIS-A hardness of the contact portion of the specific cleaning blade is preferably from 92° to 98° inclusive and more preferably from 93.5° to 96.5° inclusive.

The JIS-A hardness of the cleaning blade is measured by the following method.

The JIS-A hardness is measured according to a hardness test method described in JIS K 6253 (1997) using a type A durometer specified in JIS K 7215 (1986). Specifically, using a type A durometer (manufactured by Kobunshi Keiki Co., Ltd.) specified in JIS K 7215 (1986), an indenter is pressed against the contact portion, and the maximum value of a pointer is read within one second. The measurement is repeated 5 times, and the average of the measurement values is used to determine the JIS-A hardness of the contact portion.

Examples of a method for controlling the JIS-A hardness of the contact portion within the above-described range include: a method in which a combination of a hard segment material and a soft segment material in a resin used for the cleaning blade is controlled; a method in which the material ratio (mixing ratio) of the hard segment material to the soft segment material is controlled; and a method in which the conditions for curing the resin used for the cleaning blade (e.g., aging time and temperature) are controlled.

The contact portion having a JIS-A hardness within the above range may be formed by subjecting part of the cleaning blade to, for example, surface treatment.

The cleaning blade may have a layered structure including two or more layers. In this case, one layer including the contact portion may be a layer with a JIS-A hardness within the above range.

### (Material)

Examples of the material forming the specific cleaning blade include elastic materials.

The material forming the specific cleaning blade may contain, in addition to the elastic material, well-known additives.

### Elastic Material

No particular limitation is imposed on the elastic material, and any of various well-known materials may be used. The elastic material is, for example, a resin and is preferably a rubber.

Examples of the elastic material include polyurethane rubber, silicone rubber, fluorocarbon rubber, chloroprene rubber, and butadiene rubber, and polyurethane rubber is particularly preferable.

The polyurethane rubber is generally synthesized by polymerization of a polyisocyanate and a polyol. The polyurethane rubber may be synthesized using a resin other than the polyol that has a functional group capable of reacting with the isocyanate group. The polyurethane rubber may have a hard segment and a soft segment.

The meanings of the “hard segment” and the “soft segment” in the polyurethane rubber are as follows. The hard segment is formed of a harder material than the material forming the soft segment, and the soft segment is formed of a softer material than the material forming the soft segment.

In the polyurethane rubber, no particular limitation is imposed on the combination of the material forming the hard segment (i.e., a hard segment material) and the material forming the soft segment material (i.e., a soft segment material), and any combination of materials may be selected from well-known materials such that a first one of the materials is harder than a second one of the materials and the second one is softer than the first one. For example, combinations described below may be used.

### Soft Segment Material

The soft segment material used may be a polyether polyol. No particular limitation is imposed on the polyether polyol, and examples of the polyether polyol include polyethylene glycol, polyoxytetramethylene glycol, polyoxypropylene glycol, and polycaprolactone polyol.

Other polyols may be used for the soft segment material, and example of such polyols include a polyester polyol obtained by dehydration condensation of a diol and a dibasic acid and a polycarbonate polyol obtained by a reaction of a diol and an alkyl carbonate.

One soft segment material may be used alone, or a combination of two or more may be used.

### Hard Segment Material

The hard segment material used may be a chain extender.

No particular limitation is imposed on the chain extender, so long as it is a well-known chain extender. Examples of the chain extender include polyols having a molecular weight of 300 or less such as 1,4-butanediol, ethylene glycol, diethylene glycol, propylene glycol, dipropylene glycol, hexanediol, 1,4-cyclohexanediol, 1,4-cyclohexanedimethanol, xylene glycol, triethylene glycol, trimethylolpropane, glycerin, pentaerythritol, sorbitol, and 1,2,6-hexanetriol.

Any of these may be used alone or in combination of two or more.

The hard segment material used is preferably a resin having a functional group that can react with an isocyanate group. A flexible resin is preferable, and an aliphatic resin having a linear chain structure is more preferable in terms of flexibility. Specific preferred examples of such a resin include acrylic resins having two or more hydroxyl groups, polybutadiene resins having two or more hydroxyl groups, and epoxy resins having two or more epoxy groups.

The material forming the hard segment may be a polymer obtained by polymerization using a cross-linking agent.

When the hard segment material and the soft segment material are used, the mass ratio of the material forming the hard segment to the total amount of the hard segment material and the soft segment material (this ratio is hereinafter referred to as a “hard segment material ratio”) is preferably from 10% by mass to 30% by mass inclusive, more preferably from 13% by mass to 23% by mass inclusive, and still more preferably from 15% by mass to 20% by mass inclusive.

### Polyisocyanate

Examples of the polyisocyanate include 4,4′-diphenylmethane diisocyanate (MDI), 2,6-toluene diisocyanate (TDI), 1,6-hexane diisocyanate (HDI), 1,5-naphthalene diisocyanate (NDI), and 3,3-dimethylbiphenyl-4,4-diisocyanate (TODI).

In particular, the polyisocyanate is more preferably 4,4′-diphenylmethane diisocyanate (MDI), 1,5-naphthalene diisocyanate (NDI), or hexamethylene diisocyanate (HDI).

The content of the polyisocyanate is preferably from 10% by mass to 40% by mass inclusive, more preferably from 15% by mass to 35% by mass inclusive, and still more preferably from 20% by mass to 30% by mass inclusive based on the total mass of the polyurethane rubber.

### Cross-Linking Agent

Examples of the cross-linking agent include diols (bifunctional), triols (trifunctional), and tetraols (tetrafunctional), and these may be used in combination.

The cross-linking agent used may be an amine-based compound. Preferably, a trifunctional or higher functional cross-linking agent may be used for cross linking. Examples of the trifunctional or higher functional cross-linking agent include trimethylolpropane, glycerin, and triisopropanolamine.

The content of the cross-linking agent is preferably 2% by mass or less, more preferably 1.5% by mass or less, and still more preferably 1.0% by mass or less based on the total mass of the polyurethane rubber. When the content of the cross-linking agent is within the above range, molecular motion is less restrained by chemical crosslinking than when the content is larger than the above range, and the desired hardness is easily obtained.

### Catalyst

Examples of a catalyst include amine-based compounds such as tertiary amines, quaternary ammonium salts, and organometallic compounds such as organic tin compounds.

Examples of the tertiary amine include: trialkyl amines such as triethylamine; tetraalkyldiamines such as N,N,N′,N′-tetramethyl-1,3-butanediamine; aminoalcohols such as dimethylethanolamine; ester amines such as ethoxylated amines, ethoxylated diamines, and bis(diethylethanolamine)adipate; cyclohexylamine derivatives such as triethylenediamine (TEDA) and N,N-dimethylcyclohexylamine; morpholine derivatives such as N-methylmorpholine and N-(2-hydroxypropyl)-dimethylmorpholine; and piperazine derivatives such as N,N′-diethyl-2-methylpiperazine and N,N′-bis-(2-hydroxypropyl)-2-methylpiperazine.

Examples of the quaternary ammonium salt include 2-hydroxypropyltrimethylammonium octylate, 1,5-diazabicyclo[4.3.0]nonene-5 (DBN) octylate, 1,8-diazabicyclo[5.4.0]undecene-7 (DBU) octylate, DBU-oleate, DBU-p-toluene sulfonate, DBU-formate, and 2-hydroxypropyltrimethylammonium formate.

Examples of the organic tin compound include: dialkyl tin compounds such as dibutyltin dilaurate and dibutyltin di(2-ethylhexoate); stannous 2-ethyl caproate; and stannous oleate.

Among these catalysts, triethylenediamine (TEDA), which is a tertiary ammonium salt, may be used from the viewpoint of hydrolysis resistance, and quaternary ammonium salts may be used from the viewpoint of workability. Among the quaternary ammonium salts, highly reactive quaternary ammonium salts such as 1,5-diazabicyclo[4.3.0]nonene-5 (DBN) octylate, 1,8-diazabicyclo[5.4.0]undecene-7 (DBU) octylate, and DBU-formate may be used.

The content of the catalyst is preferably from 0.0005% by mass to 0.03% by mass inclusive and particularly preferably from 0.001% by mass to 0.01% by mass inclusive based on the total mass of the polyurethane rubber.

Any of these catalysts may be used alone or in combination of two or more.

For example, the polyurethane rubber is obtained by molding a composition obtained by mixing the above-described polyols (e.g., the hard segment material and the soft segment material), the isocyanate compound, the cross-linking agent, and the catalyst.

The amounts of the polyols, the polyisocyanate, the cross-linking agent, and the catalyst and their ratio are adjusted within the desired ranges.

The weight average molecular weight of the polyurethane rubber is preferably from 1,000 to 4,000 inclusive and more preferably from 1,500 and 3,500 inclusive.

The weight average molecular weight is measured by gel permeation chromatography (GPC). Specifically, in the measurement, a measurement apparatus HPLC 1100 manufactured by TOSOH Corporation is used, and a TSKgel GMHHR-M column+a TSKgel GMHHR-M column (7.8 mm I.D. 30 cm) manufactured by TOSOH Corporation and a chloroform solvent are used. The weight average molecular weight is computed from the measurement results using a molecular weight calibration curve produced using monodispersed polystyrene standard samples.

### Form of Cleaning Blade

The cleaning blade may have a single layer structure shown in FIG. 2 or may have a layered structure shown in FIG. 3.

When the cleaning blade 80 has a layered structure as shown in FIG. 3, it is preferable that the cleaning blade 80 includes a first layer 82 having a JIS-A hardness of from 90° to 130° inclusive and a second layer 84 having a smaller JIS-A hardness than the first layer 82, and it is more preferable that the difference between the JIS-A hardness of the first layer 82 and the JIS-A hardness of the second layer 84 is 15° or more (preferably from 15° to 25° inclusive and more preferably from 15° to 18° inclusive).

The first layer 82 shown in FIG. 3 is a layer including a contact portion 82A of the cleaning blade 80, and the second layer 84 is a layer including a non-contact corner edge 84E of the cleaning blade 80.

Since the second layer is softer than the first layer as described above, the second layer can easily absorb vibration caused by friction at the contact portion in contact with the photoconductor 1Y, so that the posture of the cleaning blade in contact with the surface of the photoconductor 1Y can be easily stabilized.

In another form of the cleaning blade, the cleaning blade has a single layer structure shown in FIG. 2, and only a portion contacting the photoconductor 1Y (i.e., the contact portion 60A in FIG. 2) is hardened to form a contact portion having a JIS-A hardness of from 90° to 130° inclusive.

### Production of Cleaning Blade

The cleaning blade having the single layer structure shown in FIG. 2 is produced, for example, by the following method.

When the cleaning blade is composed only of an elastic single layer member using the polyurethane rubber, a general polyurethane molded product production method such as a prepolymer method or a one-shot method is used.

The prepolymer method is suitable for the present exemplary embodiment because the polyurethane molded product obtained is excellent in strength and wear resistance. However, no particular limitation is imposed on the production method.

Specifically, when the cleaning blade is an elastic single layer member using the polyurethane rubber, the cleaning blade may be obtained by molding a mixture of the above-described polyols and polyisocyanate, and the chain extender, the cross-linking agent, etc. may be further added.

The composition for molding prepared by mixing the above-described materials is molded into a sheet using centrifugal molding, extrusion molding, etc., and the sheet is, for example, cut.

When the cleaning blade is formed of, for example, a thermoplastic resin, the thermoplastic resin is heated and fused, injected into a mold with a cavity corresponding to the shape of the cleaning blade by an extrusion molding method using an injection molding machine, and then cooled and solidified, and the product is removed from the mold.

When the cleaning blade has a layered structure such as a two-layer structure shown in FIG. 3, the first layer and the second layer are produced separately, and then these layers are laminated to produce the cleaning blade.

To laminate the first layer and the second layer, a double-sided adhesive tape, an adhesive, etc. may be used.

A plurality of layers may be joined to each other by pouring materials for different layers into a mold at intervals during molding to thereby join these materials without using a bonding layer.

To allow the first layer and the second layer to have different hardnesses (i.e., JIS-A hardnesses) or to allow only the contact portion to have a hardness different from the hardness of other portions, different materials may be used, or resins with different degrees of polymerization may be used. Alternatively, hardening treatment may be performed to obtain different hardnesses.

The method in which the hardening treatment is performed to obtain different hardnesses will be specifically described.

The hardening treatment is performed, for example, by the following method.

The surface of the cleaning blade member is subjected to plasma treatment to form a high-hardness coating on the surface. The high-hardness coating may be DLC (diamond-like carbon). The coating is thin, e.g., from 0.5 μm to 2.0 μm inclusive, and allows the member to maintain the desired elasticity.

### [Recording Medium]

The recording medium (e.g., the recording paper sheet P in FIG. 1) onto which a toner image is transferred may be, for example, a plain paper sheet used for electrophotographic copiers, printers, etc. or a transparency and may be a coated paper sheet obtained by coating the surface of a plain paper sheet with, for example, a resin, an art paper sheet for printing, etc.

In the example described above, the image forming apparatus according to the present exemplary embodiment is a second transfer-type image forming apparatus, but this is not a limitation.

The image forming apparatus according to the present exemplary embodiment may be a direct transfer-type image forming apparatus.

### EXAMPLES

Examples of the present disclosure will next be described. However, the present disclosure is not limited to these Examples. In the following description, “parts” and “%” are based on mass, unless otherwise specified.

The viscosity and maximum endothermic peak temperature of a toner and its absorbances at different wavenumbers are measured by the methods described above.

### (Developers A1 to A13 and B1 to B3)

### —Preparation of Styrene-Acrylic Resin Particle Dispersions—

### <Production of Resin Particle Dispersion (1)>

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1 part

A flask is charged with a solution prepared by dissolving 4 parts of an anionic surfactant (DOWFAX manufactured by Dow Chemical Company) in 550 parts of ion exchanged water, and a solution mixture prepared by mixing the above raw materials is added to the solution and emulsified. While the emulsion is gently stirred for 10 minutes, 50 parts of ion exchanged water containing 6 parts of ammonium persulfate dissolved therein is added to the emulsion. Next, the system is purged with nitrogen sufficiently and heated to 75° C. using an oil bath to allow polymerization to proceed for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 2 parts

Next, a solution mixture prepared by mixing the above raw materials is emulsified, and the emulsion is added to the flask over 120 minutes. Then emulsion polymerization is continued for 4 hours. A resin particle dispersion containing dispersed therein resin particles with a weight average molecular weight of 32,000, a glass transition temperature of 53° C., and a volume average particle diameter of 240 nm is thereby obtained. Ion exchanged water is added to the resin particle dispersion to adjust the solid content to 20% by mass, and the resulting dispersion is used as a resin particle dispersion (1).

### <Production of Resin Particle Dispersion (2)>

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A flask is charged with a solution prepared by dissolving 4 parts of an anionic surfactant (DOWFAX manufactured by Dow Chemical Company) in 550 parts of ion exchanged water, and a solution mixture prepared by mixing the above raw materials is added to the solution and emulsified. While the emulsion is gently stirred for 10 minutes, 50 parts of ion exchanged water containing 6 parts of ammonium persulfate dissolved therein is added to the emulsion. Next, the system is purged with nitrogen sufficiently and heated to 75° C. using an oil bath to allow polymerization to proceed for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 2.5 parts

Next, a solution mixture prepared by mixing the above raw materials is emulsified, and the emulsion is added to the flask over 120 minutes. Then emulsion polymerization is continued for 4 hours. A resin particle dispersion containing dispersed therein resin particles with a weight average molecular weight of 30,000, a glass transition temperature of 53° C., and a volume average particle diameter of 220 nm is thereby obtained. Ion exchanged water is added to the resin particle dispersion to adjust the solid content to 20% by mass, and the resulting dispersion is used as a resin particle dispersion (2).

### <Production of Resin Particle Dispersion (3)>

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A flask is charged with a solution prepared by dissolving 4 parts of an anionic surfactant (DOWFAX manufactured by Dow Chemical Company) in 550 parts of ion exchanged water, and a solution mixture prepared by mixing the above raw materials is added to the solution and emulsified. While the emulsion is gently stirred for 10 minutes, 50 parts of ion exchanged water containing 7 parts of ammonium persulfate dissolved therein is added to the emulsion. Next, the system is purged with nitrogen sufficiently and heated to 80° C. using an oil bath to allow polymerization to proceed for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 3.0 parts

Next, a solution mixture prepared by mixing the above raw materials is emulsified, and the emulsion is added to the flask over 120 minutes. Then emulsion polymerization is continued for 4 hours. A resin particle dispersion containing dispersed therein resin particles with a weight average molecular weight of 28,000, a glass transition temperature of 53° C., and a volume average particle diameter of 230 nm is thereby obtained. Ion exchanged water is added to the resin particle dispersion to adjust the solid content to 20% by mass, and the resulting dispersion is used as a resin particle dispersion (3).

### <Production of Resin Particle Dispersion (4)>

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 2.0 parts

A flask is charged with a solution prepared by dissolving 4 parts of an anionic surfactant (DOWFAX manufactured by Dow Chemical Company) in 550 parts of ion exchanged water, and a solution mixture prepared by mixing the above raw materials is added to the solution and emulsified. While the emulsion is gently stirred for 10 minutes, 50 parts of ion exchanged water containing 7.5 parts of ammonium persulfate dissolved therein is added to the emulsion. Next, the system is purged with nitrogen sufficiently and heated to 85° C. using an oil bath to allow polymerization to proceed for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 3.5 parts

Next, a solution mixture prepared by mixing the above raw materials is emulsified, and the emulsion is added to the flask over 120 minutes. Then emulsion polymerization is continued for 4 hours. A resin particle dispersion containing dispersed therein resin particles with a weight average molecular weight of 26,500, a glass transition temperature of 53° C., and a volume average particle diameter of 210 nm is thereby obtained. Ion exchanged water is added to the resin particle dispersion to adjust the solid content to 20% by mass, and the resulting dispersion is used as a resin particle dispersion (4).

### <Production of Resin Particle Dispersion (5)>

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 0.8 parts

A flask is charged with a solution prepared by dissolving 4 parts of an anionic surfactant (DOWFAX manufactured by Dow Chemical Company) in 550 parts of ion exchanged water, and a solution mixture prepared by mixing the above raw materials is added to the solution and emulsified. While the emulsion is gently stirred for 10 minutes, 50 parts of ion exchanged water containing 5.5 parts of ammonium persulfate dissolved therein is added to the emulsion. Next, the system is purged with nitrogen sufficiently and heated to 85° C. using an oil bath to allow polymerization to proceed for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 1.7 parts

Next, a solution mixture prepared by mixing the above raw materials is emulsified, and the emulsion is added to the flask over 120 minutes. Then emulsion polymerization is continued for 4 hours. A resin particle dispersion containing dispersed therein resin particles with a weight average molecular weight of 36,000, a glass transition temperature of 53° C., and a volume average particle diameter of 260 nm is thereby obtained. Ion exchanged water is added to the resin particle dispersion to adjust the solid content to 20% by mass, and the resulting dispersion is used as a resin particle dispersion (5).

### <Preparation of Magenta Coloring Agent Particle Dispersion>

C.I. Pigment Red 122: 50 parts

Anionic surfactant NEOGEN RK (manufactured by DAI-ICHI KOGYO SEIYAKU Co., Ltd.): 5 parts

Ion exchanged water: 220 parts

The above components are mixed and dispersed using ULTIMAIZER (manufactured by Sugino Machine Limited) at 240 MPa for 10 minutes to prepare a magenta coloring agent particle dispersion (solid concentration: 20%).

### <Preparation of Release Agent Particle Dispersion (1)>

Ester wax (WEP-2 manufactured by NOF CORPORATION): 100 parts

Anionic surfactant (NEOGEN RK manufactured by DAI-ICHI KOGYO SEIYAKU Co., Ltd.): 2.5 parts

Ion exchanged water: 250 parts

The above materials are mixed, heated to 120° C., dispersed using a homogenizer (ULTRA-TURRAX T50 manufactured by IKA), and then subjected to dispersion treatment using a Manton-Gaulin high-pressure homogenizer (manufactured by Gaulin Corporation) to thereby obtain a release agent particle dispersion (1) (solid content: 29.1% by mass) containing dispersed therein release agent particles with a volume average particle diameter of 330 nm.

### <Preparation of Release Agent Particle Dispersion (2)>

Fischer-Tropsch wax (manufactured by Nippon Seiro Co., Ltd.): 100 parts

Anionic surfactant (NEOGEN RK manufactured by DAI-ICHI KOGYO SEIYAKU Co., Ltd.): 2.5 parts

Ion exchanged water: 250 parts

The above materials are mixed, heated to 120° C., dispersed using a homogenizer (ULTRA-TURRAX T50 manufactured by IKA), and then subjected to dispersion treatment using a Manton-Gaulin high-pressure homogenizer (manufactured by Gaulin Corporation) to thereby obtain a release agent particle dispersion (2) (solid content: 29.2% by mass) containing dispersed therein release agent particles with a volume average particle diameter of 340 nm.

### <Preparation of Release Agent Particle Dispersion (3)>

Paraffin wax (FNP0090 manufactured by Nippon Seiro Co., Ltd.): 100 parts

Anionic surfactant (NEOGEN RK manufactured by DAI-ICHI KOGYO SEIYAKU Co., Ltd.): 2.5 parts

Ion exchanged water: 250 parts

The above materials are mixed, heated to 120° C., dispersed using a homogenizer (ULTRA-TURRAX T50 manufactured by IKA), and then subjected to dispersion treatment using a Manton-Gaulin high-pressure homogenizer (manufactured by Gaulin Corporation) to thereby obtain a release agent particle dispersion (3) (solid content: 29.0% by mass) containing dispersed therein release agent particles with a volume average particle diameter of 360 nm.

### <Preparation of Release Agent Particle Dispersion (4)>

Polyethylene wax (POLYWAX 725 manufactured by TOYO ADL CORPORATION): 100 parts

Anionic surfactant (NEOGEN RK manufactured by DAI-ICHI KOGYO SEIYAKU Co., Ltd.): 2.5 parts

Ion exchanged water: 250 parts

The above materials are mixed, heated to 100° C., dispersed using a homogenizer (ULTRA-TURRAX T50 manufactured by IKA), and then subjected to dispersion treatment using a Manton-Gaulin high-pressure homogenizer (manufactured by Gaulin Corporation) to thereby obtain a release agent particle dispersion (4) (solid content: 29.3% by mass) containing dispersed therein release agent particles with a volume average particle diameter of 370 nm.

### <Production of Toner A1>

Ion exchanged water: 400 parts

Resin particle dispersion (1): 200 parts

Magenta coloring agent particle dispersion: 40 parts

Release agent particle dispersion (2): 12 parts

Release agent particle dispersion (3): 24 parts

The above components are placed in a reaction vessel equipped with a thermometer, a pH meter, and a stirrer and held at 30° C. and a stirring speed of 150 rpm for 30 minutes while the temperature of the mixture is controlled from the outside using a heating mantle.

While the mixture is dispersed using a homogenizer (ULTRA-TURRAX T50 manufactured by IKA Japan), an aqueous PAC solution prepared by dissolving 2.1 parts of aluminum polychloride (PAC manufactured by Oji Paper Co., Ltd.: 30% powder) in 100 parts of ion exchanged water is added to the mixture. Then the resulting mixture is heated to 50° C., and particle diameters are measured using COULTER MULTISIZER II (manufactured by Coulter: aperture diameter: 50 μm) to adjust the volume average particle diameter to 5.0 μm. Then 115 parts of the resin particle dispersion (1) is additionally added to cause the resin particles to adhere to the surface of the aggregated particles (to form a shell structure).

Next, 20 parts of a 10 mass % aqueous NTA (nitrilotriacetic acid) metal salt solution (CHELEST 70 manufactured by Chelest) is added, and the pH of the mixture is adjusted to 9.0 using a 1N aqueous sodium hydroxide solution. Then the resulting mixture is heated to 91° C. at a heating rate of 0.05° C./minute and held at 91° C. for 3 hours to thereby obtain a toner slurry. The toner slurry obtained is cooled to 85° C. and held for 1 hour. Then the slurry is cooled to 25° C., and a magenta toner is thereby obtained. The magenta toner is re-dispersed in ion exchanged water and filtrated. This procedure is repeated to wash the toner until the electric conductivity of the filtrate reaches 20 μS/cm or less, and the product is vacuum-dried in an oven at 40° C. for 5 hours to thereby obtain toner particles.

1.5 Parts of hydrophobic silica (RY50 manufactured by Nippon Aerosil Co., Ltd.) and 1.0 part of hydrophobic titanium oxide (T805 manufactured by Nippon Aerosil Co., Ltd.) are mixed with 100 parts of the obtained toner particles using a sample mill at 10,000 rpm for 30 seconds. Then the mixture is sieved using a vibrating sieve with a mesh size of 45 μm to prepare a toner A1. The toner A1 has a volume average particle diameter of 5.7 μm.

### <Production of Developer A1>

8 Parts of the toner A1 and 92 parts of a carrier are mixed using a V blender to produce a developer A1

### (Electrostatic Image Developer A1).

### <Production of Developers A2 to A13, B1, and B2>

Magenta toners A2 to A13, B1, and B2 are obtained in the same manner as that for the toner A1 except that the resin particle dispersion used, the release agent particle dispersions used, the amount of the flocculant, coalescence temperature, holding temperature, and holding time are changed as shown in Table 1.

Electrostatic image developers A2 to A13, B1, and B2 are produced in the same manner as that for the developer A1 except that the toners obtained are used.

### <Production of Developer B3>

A magenta toner B3 is obtained in the same manner as that for the toner A1 except that the resin particle dispersion used, the release agent particle dispersions used, the amount of the flocculant, coalescence temperature, holding temperature, and holding time are changed as shown in Table 1.

An electrostatic image developer B3 is produced in the same manner as that for the developer A1 except that the toner obtained is used.

TABLE 1

| | | | | (Inη (T2) − | (Inη (T0) − | Maximum | | | |
|---|---|---|---|---|---|---|---|---|---|
| | | | | Inη (T3))/ | Inη(T1))/ | endothermic | | | |
| | | | | (T2 − T3) − | (T0 − T1) − | peak | | | |
| | (Inη (T1) − | (Inη (T2) − | (Inη (T0) − | (Inη (T1) − | (Inη (T1) − | temperature | | | Resin |
| | Inη (T2))/ | Inη (T3))/ | Inη (T1))/ | Inη (T2))/ | Inη (T2))/ | of toner | | | particle |
| Toner | (T1 − T2) | (T2 − T3) | (T0 − T1) | (T1 − T2) | (T1 − T2) | (° C.) | a/b | c/d | dispersion |
| A1 | −0.215 | −0.090 | −0.110 | 0.125 | 0.105 | 85 | 5.0 | 2.9 | (3) |
| A2 | −0.168 | −0.080 | −0.085 | 0.088 | 0.083 | 85 | 5.1 | 2.5 | (2) |
| A3 | −0.143 | −0.100 | −0.078 | 0.043 | 0.065 | 85 | 4.9 | 2.6 | (1) |
| A4 | −0.213 | −0.090 | −0.106 | 0.123 | 0.107 | 85 | 5.0 | 2.8 | (3) |
| A5 | −0.214 | −0.100 | −0.110 | 0.114 | 0.104 | 85 | 5.1 | 2.4 | (3) |
| A6 | −0.154 | −0.135 | −0.077 | 0.019 | 0.077 | 70 | 5.1 | 2.6 | (1) |
| A7 | −0.153 | −0.133 | −0.080 | 0.020 | 0.073 | 100 | 4.9 | 2.8 | (1) |
| A8 | −0.155 | −0.141 | −0.083 | 0.014 | 0.072 | 63 | 5.0 | 2.5 | (1) |
| A9 | −0.156 | −0.136 | −0.079 | 0.020 | 0.077 | 102 | 5.1 | 2.9 | (1) |
| A10 | −0.152 | −0.141 | −0.073 | 0.011 | 0.079 | 85 | 1.5 | 1.3 | (1) |
| A11 | −0.153 | −0.142 | −0.071 | 0.011 | 0.082 | 85 | 7.2 | 3.5 | (1) |
| A12 | −0.155 | −0.135 | −0.075 | 0.020 | 0.080 | 85 | 8.5 | 4.5 | (1) |
| A13 | −0.154 | −0.134 | −0.078 | 0.020 | 0.076 | 85 | 0.7 | 0.6 | (1) |
| B1 | −0.129 | −0.090 | −0.068 | 0.039 | 0.061 | 85 | 5.3 | 2.9 | (5) |
| B2 | −0.215 | −0.155 | −0.113 | 0.060 | 0.102 | 85 | 5.3 | 2.9 | (3) |
| B3 | −0.180 | −0.186 | −0.109 | −0.006 | 0.071 | 85 | 5.3 | 2.9 | (4) |

| | First release | | Second release | | Toner production conditions | | | |
|---|---|---|---|---|---|---|---|---|
| | agent particle | | agent particle | | Amount of | Coalescence | Holding | Holding |
| | dispersion | | dispersion | | flocculant | temperature | temperature | time |
| Toner | Type | Parts | Type | Parts | (parts) | (° C.) | (° C.) | (hours) |
| A1 | (2) | 12 | (3) | 24 | 2.1 | 91 | 85 | 1 |
| A2 | (2) | 12 | (3) | 24 | 2.1 | 92 | 85 | 1 |
| A3 | (2) | 12 | (3) | 24 | 2.1 | 93 | 85 | 1 |
| A4 | (2) | 12 | (3) | 24 | 1.9 | 92 | 85 | 1 |
| A5 | (2) | 12 | (3) | 24 | 1.7 | 91 | 85 | 1 |
| A6 | (1) | 12 | (2) | 24 | 1.7 | 77 | 70 | 1 |
| A7 | (3) | 12 | (4) | 24 | 1.7 | 108 | 95 | 1 |
| A8 | (1) | 28.8 | (2) | 7.2 | 1.7 | 70 | 65 | 1 |
| A9 | (3) | 7.2 | (4) | 28.8 | 1.7 | 108 | 95 | 1 |
| A10 | (2) | 12 | (3) | 24 | 1.7 | 91 | 85 | 0.5 |
| A11 | (2) | 12 | (3) | 24 | 1.7 | 92 | 85 | 2 |
| A12 | (2) | 12 | (3) | 24 | 1.7 | 93 | 85 | 3 |
| A13 | (2) | 12 | (3) | 24 | 1.7 | 92 | 85 | 0.25 |
| B1 | (2) | 12 | (3) | 24 | 2.1 | 91 | 85 | 1 |
| B2 | (2) | 12 | (3) | 24 | 1.5 | 93 | 85 | 1 |
| B3 | (2) | 12 | (3) | 24 | 2.1 | 93 | 85 | 1 |

The ratio “a/b” in Table 1 is the “ratio of the number “a” of release agent domains with an aspect ratio of 5 or more to the number “b” of release agent domains with an aspect ratio of less than 5,” and the ratio “c/d” is the “ratio of the total cross-sectional area “c” of the release agent domains with an aspect ratio of 5 or more to the total cross-sectional area “d” of the release agent domains with an aspect ratio of less than 5.”

### (Production of Cleaning Blades C1 to C3)

Cleaning blades C1 to C3 to be installed in an electrophotographic copier described later are produced as follows.

### <Production of Cleaning Blade C1>

A urethane resin with a JIS-A hardness of 90° is molded using a centrifugal molding machine to produce a cleaning blade C1.

### <Production of Cleaning Blade C2>

A urethane resin with a JIS-A hardness of 80° (a low-hardness material layer) is molded using a centrifugal molding machine, and a urethane resin with a JIS-A hardness of 90° (a high-hardness material layer) is molded centrifugally onto the low-hardness material layer to thereby produce a cleaning blade C2.

### <Production of Cleaning Blade C3>

A urethane resin with a JIS-A hardness of 75° (a low-hardness material layer) is molded using a centrifugal molding machine, and a urethane resin with a JIS-A hardness of 90° (a high-hardness material layer) is molded centrifugally onto the low-hardness material layer to thereby produce a cleaning blade C3.

### Examples 1 to 41 and Comparative Examples 1 to 9

A commercial electrophotographic copier (DOCU CENTRE COLOR 450 manufactured by Fuji Xerox Co., Ltd.), which is an image forming apparatus including a cleaning unit using a cleaning blade, is prepared. One of the cleaning blades shown in Tables 2 to 4 is placed in the electrophotographic copier, and one of the developers shown in Tables 2 to 4 is housed in a developing device.

The cleaning blade is placed such that the region with a JIS-A hardness of 90° or more is in contact with a photoconductor. The placement conditions for the cleaning blade, i.e., the pressing pressure NF and the contact angle WA, are as shown in Tables 2 to 4.

### (Evaluation)

### Image Formation in High-Temperature High-Humidity Environment

Each of the electrophotographic copiers in the Examples and Comparative Examples is used to output an image with an area coverage of 20% on 5,000 plain paper sheets (A4 paper P manufactured by Fuji Xerox Co., Ltd.) (5,000 pv (pv=print volume (the number of sheets subjected to image formation processing))) in a high-temperature high-humidity environment (28° C. and 85% RH), and then a half-tone 50% image is printed over the entire area of one sheet.

### Image Formation in Low-Temperature High-Humidity Environment

Each of the electrophotographic duplicators in the Examples and Comparative Examples is used to output an image with an area coverage of 1% on 5,000 plain paper sheets (A4 paper P manufactured by Fuji Xerox Co., Ltd.) (5,000 pv (pv=print volume (the number of sheets subjected to image formation processing))) in a low-temperature low-humidity environment (10° C. and 15% RH), and then a half-tone 50% image is printed over the entire area of one sheet.

### <Evaluation of Adhering of Toner to Surface of Image Holding Member (i.e., Photoconductor)>

The surface of the photoconductor after each of the two types of image formation described above is observed visually, and the degree of adhering of the toner to the surface of the photoconductor (i.e., filming) is evaluated according to the following criteria.

A: No adhering of the toner to the surface of the photoconductor (i.e., filming) is found.

B: A very slight degree of adhering of the toner to the surface of the photoconductor (i.e., filming) is found.

C: Adhering of the toner to the surface of the photoconductor (i.e., filming) occurs, and steaks are formed.

### <Examination of Passage of Toner>

A cellophane tape is applied to the surface of the photoconductor after each of the two types of image formation described above. Then the cellophane tape is removed and applied to a white paper sheet, and the toner on the paper sheet is observed to examine passage of the toner. The degree of passage of the residual toner is evaluated according to the following criteria.

A: No toner passage is found.

B: Slight toner passage is found.

C: Toner passage is found over the entire cellophane tape.

### <Evaluation of Image Defects>

The last image outputted in each of the two types of image formation is observed visually to evaluate the degree of occurrence of image defects according to the following criteria.

A: No image defects are found.

B: Slight streak-like image defects are found.

C: Streak-like image defects are found.

D: Clear streak-like image defects are found.

TABLE 2

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | | High-temperature high- | | | Low-temperature low- | | |
| | | | | | between | pressure | Contact | humidity environment | | | humidity environment | | |
| | | | | Layer | layers | NF | angle WA | | | Image | | | Image |
| | | Developer | Type | structure | [degrees] | [gf/mm] | [degrees] | Adhering | Passage | defects | Adhering | Passage | defects |
| Example | 1 | A1 | C1 | Single | — | 2.9 | 11 | B | A | B | A | C | D |
| | 2 | A2 | | layer | — | 2.9 | 11 | B | B | A | B | B | B |
| | 3 | A3 | | | — | 2.9 | 11 | C | B | D | B | B | A |
| | 4 | A4 | | | — | 2.9 | 11 | B | A | A | A | C | D |
| | 5 | A5 | | | — | 2.9 | 11 | B | A | A | A | C | D |
| | 6 | A6 | | | — | 2.9 | 11 | C | A | C | B | B | B |
| | 7 | A7 | | | — | 2.9 | 11 | C | A | D | B | B | A |
| | 8 | A8 | | | — | 2.9 | 11 | C | B | D | B | B | B |
| | 9 | A9 | | | — | 2.9 | 11 | B | A | B | B | B | A |
| | 10 | A10 | | | — | 2.9 | 11 | C | B | B | B | B | B |
| | 11 | A11 | | | — | 2.9 | 11 | C | B | C | B | B | B |
| | 12 | A12 | | | — | 2.9 | 11 | C | A | C | B | B | A |
| | 13 | A13 | | | — | 2.9 | 11 | B | A | B | B | B | A |
| Comparative | 1 | B1 | | | — | 2.9 | 11 | B | B | B | A | C | D |
| Example | 2 | B2 | | | — | 2.9 | 11 | B | B | A | A | C | D |
| | 3 | B3 | | | — | 2.9 | 11 | C | B | D | B | B | A |

TABLE 3

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | | High-temperature high- | | | Low-temperature low- | | |
| | | | | | between | pressure | Contact | humidity environment | | | humidity environment | | |
| | | | | Layer | layers | NF | angle WA | | | Image | | | Image |
| | | Developer | Type | structure | [degrees] | [gf/mm] | [degrees] | Adhering | Passage | defects | Adhering | Passage | defects |
| Example | 14 | A1 | C2 | Double | 10 | 2.6 | 10.5 | B | A | B | A | C | B |
| | 15 | A2 | | layer | 10 | 2.6 | 10.5 | B | B | B | B | B | B |
| | 16 | A3 | | | 10 | 2.6 | 10.5 | C | B | C | B | B | A |
| | 17 | A4 | | | 10 | 2.6 | 10.5 | B | A | A | A | C | C |
| | 18 | A5 | | | 10 | 2.6 | 10.5 | B | A | A | A | C | B |
| | 19 | A6 | | | 10 | 2.6 | 10.5 | A | A | B | B | A | B |
| | 20 | A7 | | | 10 | 2.6 | 10.5 | B | A | B | A | B | A |
| | 21 | A8 | | | 10 | 2.6 | 10.5 | C | B | B | B | A | B |
| | 22 | A9 | | | 10 | 2.6 | 10.5 | A | A | B | B | A | A |
| | 23 | A10 | | | 10 | 2.6 | 10.5 | B | B | B | B | B | B |
| | 24 | A11 | | | 10 | 2.6 | 10.5 | B | B | B | A | B | B |
| | 25 | A12 | | | 10 | 2.6 | 10.5 | B | A | B | A | B | A |
| | 26 | A13 | | | 10 | 2.6 | 10.5 | B | A | B | B | B | A |
| Comparative | 4 | B1 | | | 10 | 2.6 | 10.5 | A | B | B | A | C | D |
| Example | 5 | B2 | | | 10 | 2.6 | 10.5 | A | B | A | A | C | D |
| | 6 | B3 | | | 10 | 2.6 | 10.5 | C | B | D | B | B | A |

TABLE 4

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | | High-temperature high- | | | Low-temperature low- | | |
| | | | | | between | pressure | Contact | humidity environment | | | humidity environment | | |
| | | | | Layer | layers | NF | angle WA | | | Image | | | Image |
| | | Developer | Type | structure | [degrees] | [gf/mm] | [degrees] | Adhering | Passage | defects | Adhering | Passage | defects |
| Example | 27 | A1 | C3 | Double | 15 | 2.6 | 10.5 | B | B | B | A | B | B |
| | 28 | A2 | | layer | 15 | 2.6 | 10.5 | B | A | B | B | B | B |
| | 29 | A3 | | | 15 | 2.6 | 10.5 | C | B | C | B | B | A |
| | 30 | A4 | | | 15 | 2.6 | 10.5 | B | A | A | A | C | C |
| | 31 | A5 | | | 15 | 2.6 | 10.5 | B | A | A | A | B | B |
| | 32 | A6 | | | 15 | 2.6 | 10.5 | A | A | A | B | A | B |
| | 33 | A7 | | | 15 | 2.6 | 10.5 | B | A | B | A | B | A |
| | 34 | A8 | | | 15 | 2.6 | 10.5 | B | B | B | B | B | B |
| | 35 | A9 | | | 15 | 2.6 | 10.5 | A | A | B | B | A | A |
| | 36 | A10 | | | 15 | 2.6 | 10.5 | A | B | B | A | B | B |
| | 37 | A11 | | | 15 | 2.6 | 10.5 | B | B | B | A | B | B |
| | 38 | A12 | | | 15 | 2.6 | 10.5 | A | B | A | A | A | B |
| | 39 | A13 | | | 15 | 2.6 | 10.5 | A | A | A | A | B | A |
| | 40 | A13 | | | 15 | 3.2 | 9.0 | C | A | B | B | A | A |
| | 41 | A13 | | | 15 | 2.0 | 12.0 | A | B | A | A | C | B |
| Comparative | 7 | B1 | | | 15 | 2.6 | 10.5 | A | B | B | A | C | D |
| Example | 8 | B2 | | | 15 | 2.6 | 10.5 | A | B | A | A | C | D |
| | 9 | B3 | | | 15 | 2.6 | 10.5 | C | B | D | B | B | A |

As can be seen from Tables 2 to 4, in each of the image forming apparatuses in the Examples, the toner used meets the following requirements: (ln η(T1)−ln η(T2))/(T1−T2) is −0.14 or less; (ln η(T2)−ln η(T3))/(T2−T3) is −0.15 or more; and (ln η(T2)−ln η(T3))/(T2−T3) is larger than (ln η(T1)−ln η(T2))/(T1−T2). With the image forming apparatuses in the Examples, even in the high-temperature high-humidity environment and in the low-temperature low-humidity environment, the adhering of the toner to the surface of the photoconductor and the passage of the toner below the cleaning blade are more effectively prevented than with the image forming apparatuses in the Comparative Examples that do not meet at least one of the requirements, and the occurrence of image defects is also more effectively prevented.

### (Developers A101 to A113 and B101 to B103)

### —Preparation of Amorphous Polyester Resin Particle Dispersions—

### <Production of Resin Particle Dispersion (101)>

A dry three-neck flask is charged with 60 parts of dimethyl terephthalate, 74 parts of dimethyl fumarate, 30 parts of dodecenyl succinic acid anhydride, 22 parts of trimellitic acid, 138 parts of propylene glycol, and 0.3 parts of dibutyl tin oxide. The mixture is allowed to react in a nitrogen atmosphere at 185° C. for 3 hours while water generated by the reaction is removed from the system to the outside. Then, while the pressure of the system is gradually reduced, the temperature is increased to 240° C. The reaction is allowed to further proceed for 4 hours, and the mixture is cooled. An amorphous polyester resin (101) with a weight average molecular weight of 39,000 is thereby produced.

Next, 200 parts of the amorphous polyester resin (101) with insoluble components removed, 100 parts of methyl ethyl ketone, 35 parts of isopropyl alcohol, and 7.0 parts of a 10 mass% ammonia water solution are placed in a separable flask, mixed sufficiently, and dissolved. Then ion exchanged water is added dropwise to the mixture at a feed rate of 8 g/minute using a feed pump while the mixture is heated to 40° C. and stirred. When the solution becomes uniformly cloudy, the feed rate of the ion exchange water is increased to 15 g/minute to perform phase inversion, and the dropwise addition is stopped when the total feed amount reaches 580 parts. Then the solvent is removed under reduced pressure to thereby obtain an amorphous polyester resin particle dispersion (101) (a resin particle dispersion (101)). The polyester resin particles obtained have a volume average particle diameter of 170 nm, and the solid concentration of the resin particles is 35%.

### <Preparation of Resin Particle Dispersions (102) to (105)>

Resin particle dispersions (102) to (105) are obtained in the same manner as that for the resin particle dispersion (101) except that the conditions are changed to those shown in Table 5.

TABLE 5

| | | Weight |
|---|---|---|
| | | average |
| | | molecular |
| | | weight of |
| | Polymerization time | polyester |
| | of resin | resin |
| Amorphous polyester | 3 hours at 185° C. and | 39,000 |
| resin particle dispersion | 4 hours at 240° C. | |
| (101) | | |
| Amorphous polyester | 2.5 hours at 185° C. and | 37,000 |
| resin particle dispersion | 3.5 hours at 240° C. | |
| (102) | | |
| Amorphous polyester | 2 hours at 185° C. and | 35,000 |
| resin particle dispersion | 3 hours at 240° C. | |
| (103) | | |
| Amorphous polyester | 1.5 hours at 185° C. and | 33,000 |
| resin particle dispersion | 2.5 hours at 240° C. | |
| (104) | | |
| Amorphous polyester | 4 hours at 185° C. and | 43,000 |
| resin particle dispersion | 5h ours at 240° C. | |
| (105) | | |

### <Production of Toner A101>

Ion exchanged water: 400 parts

Amorphous polyester resin particle dispersion (101): 200 parts

Magenta coloring agent particle dispersion: 40 parts

Release agent particle dispersion (2): 12 parts

Release agent particle dispersion (3): 24 parts

The above components are placed in a reaction vessel equipped with a thermometer, a pH meter, and a stirrer and held at 30° C. and a stirring speed of 150 rpm for 30 minutes while the temperature of the mixture is controlled from the outside using a heating mantle.

While the mixture is dispersed using a homogenizer (ULTRA-TURRAX T50 manufactured by IKA Japan), an aqueous PAC solution prepared by dissolving 2.1 parts of aluminum polychloride (PAC manufactured by Oji Paper Co., Ltd.: 30% powder) in 100 parts of ion exchanged water is added to the mixture. Then the resulting mixture is heated to 50° C., and particle diameters are measured using COULTER MULTISIZER II (manufactured by Coulter: aperture diameter: 50 μm) to adjust the volume average particle diameter to 4.9 μm. Then 115 parts of the amorphous polyester resin particle dispersion (101) is additionally added to cause the resin particles to adhere to the surface of the aggregated particles (to form a shell structure).

Next, 20 parts of a 10 mass % aqueous NTA (nitrilotriacetic acid) metal salt solution (CHELEST 70 manufactured by Chelest) is added, and the pH of the mixture is adjusted to 9.0 using a 1N aqueous sodium hydroxide solution. Then the resulting mixture is heated to 91° C. at a heating rate of 0.05° C./minute and held at 91° C. for 3 hours to obtain a toner slurry. The toner slurry obtained is cooled to 85° C. and held for 1 hour. Then the slurry is cooled to 25° C., and a magenta toner is thereby obtained. The magenta toner is re-dispersed in ion exchanged water and filtrated. This procedure is repeated to wash the toner until the electric conductivity of the filtrate reaches 20 μS/cm or less, and the product is vacuum-dried in an oven at 40° C. for 5 hours to thereby obtain toner particles.

1.5 Parts of hydrophobic silica (RY50 manufactured by Nippon Aerosil Co., Ltd.) and 1.0 part of hydrophobic titanium oxide (T805 manufactured by Nippon Aerosil Co., Ltd.) are mixed with 100 parts of the obtained toner particles using a sample mill at 10,000 rpm for 30 seconds. Then the mixture is sieved using a vibrating sieve with a mesh size of 45 μm to prepare a toner A101. The toner A101 has a volume average particle diameter of 5.8 μm.

### <Production of Developer A101>

8 Parts of the toner A101 and 92 parts of a carrier are mixed using a V blender to produce a developer A101 (an electrostatic image developer A101).

### <Production of Developers A102 to A113, B101, and B102>

Magenta toners A102 to A113, B101, and B102 are obtained in the same manner as that for the toner A101 except that the resin particle dispersion used, the release agent particle dispersions used, the amount of the flocculant, coalescence temperature, holding temperature, and holding time are changed as shown in Table 6.

Electrostatic image developers A102 to A113, B101, and B102 are produced in the same manner as that for the developer A101 except that the toners obtained are used.

### <Production of Developer B103>

A magenta toner B103 is obtained in the same manner as that for the toner A101 except that the resin particle dispersion used, the release agent particle dispersions used, the amount of the flocculant, coalescence temperature, holding temperature, and holding time are changed as shown in Table 6.

An electrostatic image developer B103 is produced in the same manner as that for the developer A101 except that the toner obtained is used.

TABLE 6

| | | | | (Inη (T2) − | (Inη (T0) − | Maximum | | | | | |
|---|---|---|---|---|---|---|---|---|---|---|---|
| | | | | Inη (T3))/ | Inη(T1))/ | endothermic | | | | | |
| | | | | (T2 − T3) − | (T0 − T1) − | peak | | | | | |
| | (Inη (T1) − | (Inη (T2) − | (Inη (T0) − | (Inη (T1) − | (Inη (T1) − | temperature | | | | | Resin |
| | Inη (T2))/ | Inη (T3))/ | Inη (T1))/ | Inη (T2))/ | Inη (T2))/ | of toner | | | IR ratio | | particle |
| Toner | (T1 − T2) | (T2 − T3) | (T0 − T1) | (T1 − T2) | (T1 − T2) | (° C.) | a/b | c/d | (a) | (b) | dispersion |
| A101 | −0.220 | −0.110 | −0.100 | 0.110 | 0.120 | 85 | 5.2 | 2.7 | 0.30 | 0.16 | (103) |
| A102 | −0.163 | −0.070 | −0.080 | 0.093 | 0.083 | 85 | 4.9 | 2.3 | 0.31 | 0.15 | (102) |
| A103 | −0.141 | −0.100 | −0.065 | 0.041 | 0.076 | 85 | 4.8 | 2.7 | 0.29 | 0.17 | (101) |
| A104 | −0.222 | −0.080 | −0.111 | 0.142 | 0.111 | 85 | 5.2 | 2.7 | 0.33 | 0.16 | (103) |
| A105 | −0.211 | −0.110 | −0.101 | 0.101 | 0.110 | 85 | 5.0 | 2.5 | 0.34 | 0.17 | (103) |
| A106 | −0.156 | −0.131 | −0.075 | 0.025 | 0.081 | 70 | 4.9 | 2.4 | 0.30 | 0.16 | (101) |
| A107 | −0.154 | −0.135 | −0.072 | 0.019 | 0.082 | 100 | 4.7 | 2.9 | 0.29 | 0.15 | (101) |
| A108 | −0.155 | −0.139 | −0.079 | 0.016 | 0.076 | 85 | 1.6 | 1.4 | 0.33 | 0.17 | (101) |
| A109 | −0.154 | −0.141 | −0.077 | 0.013 | 0.077 | 85 | 7.1 | 3.3 | 0.29 | 0.18 | (101) |
| A110 | −0.151 | −0.136 | −0.072 | 0.015 | 0.079 | 63 | 5.2 | 2.9 | 0.27 | 0.16 | (103) |
| A111 | −0.153 | −0.140 | −0.081 | 0.013 | 0.072 | 102 | 5.1 | 2.5 | 0.34 | 0.17 | (103) |
| A112 | −0.152 | −0.133 | −0.080 | 0.019 | 0.072 | 85 | 8.6 | 4.6 | 0.33 | 0.16 | (103) |
| A113 | −0.151 | −0.133 | −0.071 | 0.018 | 0.080 | 85 | 0.8 | 0.5 | 0.31 | 0.15 | (103) |
| B101 | −0.127 | −0.110 | −0.055 | 0.017 | 0.072 | 85 | 5.0 | 2.7 | 0.34 | 0.16 | (105) |
| B102 | −0.221 | −0.160 | −0.132 | 0.061 | 0.089 | 85 | 5.1 | 2.8 | 0.28 | 0.18 | (103) |
| B103 | −0.203 | −0.224 | −0.119 | −0.021 | 0.084 | 85 | 5.3 | 3.0 | 0.36 | 0.17 | (104) |

| | First release | | Second release | | Toner production conditions | | | |
|---|---|---|---|---|---|---|---|---|
| | agent particle | | agent particle | | Amount of | Coalescence | Holding | Holding |
| | dispersion | | dispersion | | flocculant | temperature | temperature | time |
| Toner | Type | Parts | Type | Parts | (parts) | (° C.) | (° C.) | (hours) |
| A101 | (2) | 12 | (3) | 24 | 2.1 | 91 | 85 | 1 |
| A102 | (2) | 12 | (3) | 24 | 2.1 | 92 | 85 | 1 |
| A103 | (2) | 12 | (3) | 24 | 2.1 | 93 | 85 | 1 |
| A104 | (2) | 12 | (3) | 24 | 1.9 | 92 | 85 | 1 |
| A105 | (2) | 12 | (3) | 24 | 1.7 | 91 | 85 | 1 |
| A106 | (1) | 12 | (2) | 24 | 1.7 | 77 | 70 | 1 |
| A107 | (3) | 12 | (4) | 24 | 1.7 | 108 | 95 | 1 |
| A108 | (2) | 12 | (3) | 24 | 1.7 | 91 | 85 | 0.5 |
| A109 | (2) | 12 | (3) | 24 | 1.7 | 92 | 85 | 2 |
| A110 | (1) | 28.8 | (2) | 7.2 | 1.7 | 70 | 65 | 1 |
| A111 | (3) | 7.2 | (4) | 28.8 | 1.7 | 108 | 95 | 1 |
| A112 | (2) | 12 | (3) | 24 | 1.7 | 93 | 85 | 3 |
| A113 | (2) | 12 | (3) | 24 | 1.7 | 92 | 85 | 0.25 |
| B101 | (2) | 12 | (3) | 24 | 2.1 | 91 | 85 | 1 |
| B102 | (2) | 12 | (3) | 24 | 1.5 | 93 | 85 | 1 |
| B103 | (2) | 12 | (3) | 24 | 1.5 | 93 | 85 | 1 |

The ratios “a/b” and “c/d” in Table 6 are the same as those in Table 1. The “IR ratio (a)” is the “ratio of the absorbance of the toner particles in infrared absorption spectrum analysis at a wavenumber of 1,500 cm⁻¹ to the absorbance at a wavenumber of 720 cm⁻¹ (i.e., the absorbance at a wavenumber of 1,500 cm⁻¹/the absorbance at a wavenumber of 720 cm⁻¹),” and the “IR ratio (b)” is the “ratio of the absorbance of the toner particles in infrared absorption spectrum analysis at a wavenumber of 820 cm⁻¹ to the absorbance at a wavenumber of 720 cm⁻¹ (i.e., the absorbance at a wavenumber of 820 cm⁻¹/the absorbance at a wavenumber of 720 cm⁻¹).”

### Examples 101 to 141 and Comparative Examples 101 to 109

A commercial electrophotographic copier (DOCU CENTRE COLOR 450 manufactured by Fuji Xerox Co., Ltd.), which is an image forming apparatus equipped with a cleaning unit using a cleaning blade, is prepared. One of the cleaning blades shown in Tables 7 to 9 is placed in the electrophotographic copier, and one of the developers shown in Tables 7 to 9 is housed in a developing device.

The placement conditions for the cleaning blade, i.e., the pressing pressure NF and the contact angle WA, are as shown in Tables 7 to 9.

### (Evaluation)

Images are formed in a high-temperature high-humidity environment and in a low-temperature low-humidity environment in the same manner as described above, and adhering of the toner to the surface of the photoconductor, the passage of the toner below the cleaning blade, and the occurrence of image defects are evaluated.

TABLE 7

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | Contact | High-temperature high- | | | Low-temperature low- | | |
| | | | | | between | pressure | angle | humidity environment | | | humidity environment | | |
| | | | | Layer | layers | NF | WA | | | Image | | | Image |
| | | Developer | Type | structure | [degrees] | [gf/mm] | [degrees] | Adhering | Passage | defects | Adhering | Passage | defects |
| Example | 101 | A101 | C1 | Single | — | 2.9 | 11 | B | A | B | A | C | D |
| | 102 | A102 | | layer | — | 2.9 | 11 | B | B | A | B | B | B |
| | 103 | A103 | | | — | 2.9 | 11 | C | B | D | B | B | A |
| | 104 | A104 | | | — | 2.9 | 11 | B | A | A | A | B | C |
| | 105 | A105 | | | — | 2.9 | 11 | B | A | A | A | C | D |
| | 106 | A106 | | | — | 2.9 | 11 | C | B | C | B | B | B |
| | 107 | A107 | | | — | 2.9 | 11 | C | A | C | B | B | A |
| | 108 | A108 | | | — | 2.9 | 11 | C | B | D | B | B | B |
| | 109 | A109 | | | — | 2.9 | 11 | B | A | B | B | C | A |
| | 110 | A110 | | | — | 2.9 | 11 | C | A | B | B | B | B |
| | 111 | A111 | | | — | 2.9 | 11 | C | B | C | B | C | B |
| | 112 | A112 | | | — | 2.9 | 11 | C | A | C | B | B | A |
| | 113 | A113 | | | — | 2.9 | 11 | B | A | B | B | B | A |
| Comparative | 101 | B101 | | | — | 2.9 | 11 | B | B | B | A | C | D |
| Example | 102 | B102 | | | — | 2.9 | 11 | B | B | A | A | C | D |
| | 103 | B103 | | | — | 2.9 | 11 | C | B | D | B | B | A |

TABLE 8

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | Contact | High-temperature high- | | | Low-temperature low- | | |
| | | | | | between | pressure | angle | humidity environment | | | humidity environment | | |
| | | | | Layer | layers | NF | WA | | | Image | | | Image |
| | | Developer | Type | structure | [degrees] | [gf/mm] | [degrees] | Adhering | Passage | defects | Adhering | Passage | defects |
| Example | 114 | A101 | C2 | Double | 10 | 2.6 | 10.5 | B | A | B | A | C | B |
| | 115 | A102 | | layer | 10 | 2.6 | 10.5 | B | B | B | B | B | B |
| | 116 | A103 | | | 10 | 2.6 | 10.5 | C | B | C | B | B | A |
| | 117 | A104 | | | 10 | 2.6 | 10.5 | B | A | A | A | C | C |
| | 118 | A105 | | | 10 | 2.6 | 10.5 | B | A | A | A | C | B |
| | 119 | A106 | | | 10 | 2.6 | 10.5 | A | B | B | B | A | B |
| | 120 | A107 | | | 10 | 2.6 | 10.5 | B | A | B | A | B | A |
| | 121 | A108 | | | 10 | 2.6 | 10.5 | C | B | B | B | A | B |
| | 122 | A109 | | | 10 | 2.6 | 10.5 | A | A | B | B | B | A |
| | 123 | A110 | | | 10 | 2.6 | 10.5 | B | A | B | B | B | B |
| | 124 | A111 | | | 10 | 2.6 | 10.5 | A | B | B | A | A | B |
| | 125 | A112 | | | 10 | 2.6 | 10.5 | B | A | B | A | B | A |
| | 126 | A113 | | | 10 | 2.6 | 10.5 | B | A | B | B | B | A |
| Comparative | 104 | B101 | | | 10 | 2.6 | 10.5 | A | B | B | A | C | D |
| Example | 105 | B102 | | | 10 | 2.6 | 10.5 | A | B | A | A | C | D |
| | 106 | B103 | | | 10 | 2.6 | 10.5 | C | B | D | B | B | B |

TABLE 9

| | | | Cleaning blade | | | | | | | | | | |
|---|---|---|---|---|---|---|---|---|---|---|---|---|---|
| | | | | | Difference | | | Evaluation | | | | | |
| | | | | | in hardness | Pressing | Contact | High-temperature high- | | | Low-temperature low- | | |
| | | | | | between | pressure | angle | humidity environment | | | humidity environment | | |
| | | | | Layer | layers | NF | WA | | | Image | | | Image |
| | | Developer | Type | structure | [degrees] | [gf/mm] | [degrees] | Adhering | Passage | defects | Adhering | Passage | defects |
| Example | 127 | A101 | C3 | Double | 15 | 2.6 | 10.5 | B | B | B | A | B | B |
| | 128 | A102 | | layer | 15 | 2.6 | 10.5 | B | A | B | B | B | B |
| | 129 | A103 | | | 15 | 2.6 | 10.5 | C | B | C | B | B | A |
| | 130 | A104 | | | 15 | 2.6 | 10.5 | B | A | A | A | C | C |
| | 131 | A105 | | | 15 | 2.6 | 10.5 | B | A | A | A | B | B |
| | 132 | A106 | | | 15 | 2.6 | 10.5 | A | B | A | B | A | B |
| | 133 | A107 | | | 15 | 2.6 | 10.5 | B | A | B | A | B | A |
| | 134 | A108 | | | 15 | 2.6 | 10.5 | B | B | B | B | B | B |
| | 135 | A109 | | | 15 | 2.6 | 10.5 | A | A | A | B | A | A |
| | 136 | A110 | | | 15 | 2.6 | 10.5 | A | B | B | A | B | A |
| | 137 | A111 | | | 15 | 2.6 | 10.5 | B | A | B | A | B | B |
| | 138 | A112 | | | 15 | 2.6 | 10.5 | A | B | A | A | A | B |
| | 139 | A113 | | | 15 | 2.6 | 10.5 | A | A | A | A | B | A |
| | 140 | A113 | | | 15 | 3.2 | 9.0 | C | A | B | B | A | A |
| | 141 | A113 | | | 15 | 2.0 | 12.0 | A | B | A | A | C | B |
| Comparative | 107 | B101 | | | 15 | 2.6 | 10.5 | A | B | B | A | C | D |
| Example | 108 | B102 | | | 15 | 2.6 | 10.5 | A | B | A | A | C | D |
| | 109 | B103 | | | 15 | 2.6 | 10.5 | C | B | D | A | B | A |

As can be seen from Tables 7 to 9, in each of the image forming apparatuses in the Examples, the toner used meets the following requirements: (ln η(T1)−ln η(T2))/(T1−T2) is −0.14 or less; (ln η(T2)−ln η(T3))/(T2−T3) is −0.15 or more; and (ln η(T2)−ln η(T3))/(T2−T3) is larger than (ln η(T1)−ln η(T2))/(T1−T2). With the image forming apparatuses in the Examples, even in the high-temperature high-humidity environment and in the low-temperature low-humidity environment, the adhering of the toner to the surface of the photoconductor and the passage of the toner below the cleaning blade are more effectively prevented than with the image forming apparatuses in the Comparative Examples that do not meet at least one of the requirements, and the occurrence of image defects is also more effectively prevented.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising:
a photoconductor;
a charging roller configured to charge a surface of the photoconductor;
a light source configured to form an electrostatic image on the charged surface of the photoconductor;
a developing device configured to contain a toner for electrostatic image development and configured to develop the electrostatic image formed on the surface of the photoconductor with the toner to thereby form a toner image;
a transfer belt configured to transfer the toner image formed on the surface of the photoconductor onto a surface of a recording medium;
a cleaning unit that includes a cleaning blade,
wherein the cleaning unit is configured to clean the surface of the photoconductor; and
a fixing roller configured to fix the toner image transferred onto the surface of the recording medium,
wherein the cleaning blade has a contact portion configured to contact the surface of the photoconductor, the contact portion having a JIS-A hardness of from 90° to 130° inclusive,
wherein the toner satisfies the following formulas:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3), and
wherein η(T1) is the viscosity of the toner at 60° C., η(T2) is the viscosity of the toner at 90° C., and η(T3) is the viscosity of the toner at 130° C.

2. The image forming apparatus according to claim 1, wherein the toner satisfies (ln η(T0)−ln η(T1))/(T0−T1)≥−0.12 and (ln η(T0)−ln η(T1))/(T0−T1)>(ln η(T1)−ln η(T2))/(T1−T2), wherein η(T0) is the viscosity η of the toner at T0=40° C.

3. The image forming apparatus according to claim 1, wherein the toner satisfies the following formula:
(ln η(T1)−ln η(T2))/(T1−T2)≤−0.16.

4. The image forming apparatus according to claim 1, wherein the toner satisfies the following formula:
(ln η(T2)−ln η(T3))/(T2−T3)≥−0.13.

5. The image forming apparatus according to claim 1, wherein the toner contains a release agent, and
wherein the toner satisfies the following formula:
1.0<a/b<8.0,
wherein a is the number of release agent domains with an aspect ratio of 5 or more in the toner, and b is the number of release agent domains with an aspect ratio of less than 5 in the toner.

6. The image forming apparatus according to claim 1, wherein the toner contains a release agent, and
wherein the toner satisfies the following formula:
1.0<c/d<4.0,
wherein c is the total cross-sectional area of release agent domains with an aspect ratio of 5 or more in the toner, and d is the total cross-sectional area of release agent domains with an aspect ratio of less than 5 in the toner.

7. The image forming apparatus according to claim 1, wherein the toner has a maximum endothermic peak temperature within the range of 70° C. to 100° C.

8. The image forming apparatus according to claim 1, wherein the toner has a maximum endothermic peak temperature within the range of 75° C. to 95° C.

9. The image forming apparatus according to claim 1, wherein the toner contains a styrene-acrylic resin as a binder resin.

10. The image forming apparatus according to claim 1, wherein the toner contains an amorphous polyester resin as a binder resin.

11. The image forming apparatus according to claim 1, wherein the cleaning blade has a layered structure.

12. The image forming apparatus according to claim 11, wherein the layered structure includes a first layer having a JIS-A hardness of from 90° to 130° inclusive and a second layer having a smaller JIS-A hardness than the first layer.

13. The image forming apparatus according to claim 1, wherein a pressure applied between the cleaning blade and the surface of the photoconductor is from 2.0 g/mm to 3.2 g/mm inclusive.

14. An image forming apparatus comprising:
a photoconductor; and
a cleaning unit that includes a cleaning blade,
wherein the cleaning unit is configured to clean a surface of the photoconductor;
wherein the cleaning blade has a contact portion configured to contact the surface of the photoconductor, the contact portion having a JIS-A hardness of from 90° to 130° inclusive,
wherein the toner satisfies the following formulas:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3), and
wherein η(T1) is the viscosity of the toner at 60° C., η(T2) is the viscosity of the toner at 90° C., and η(T3) is the viscosity of the toner at 130° C.

15. An image forming apparatus comprising:
an image holding means for holding an image;
a charging means for charging a surface of the image holding means;
an electrostatic image forming means for forming an electrostatic image on the charged surface of the image holding means;
a developing means for developing the electrostatic image formed on the surface of the image holding means with toner to thereby form a toner image;
a transfer means for transferring the toner image formed on the surface of the image holding means onto a surface of a recording medium;
a cleaning means for cleaning the surface of the image holding means; and
a fixing means for fixing the toner image transferred onto the surface of the recording medium,
wherein the cleaning means has a contact means for contacting the surface of the image holding means, the contact means having a JIS-A hardness of from 90° to 130° inclusive,
wherein the toner satisfies the following formulas:
(ln η(T1)−ln η(T2))/(T1−T2)≤−0.14;
(ln η(T2)−ln η(T3))/(T2−T3)≥−0.15; and
(ln η(T1)−ln η(T2))/(T1−T2)<(ln η(T2)−ln η(T3))/(T2−T3), and
wherein η(T1) is the viscosity of the toner at 60° C., η(T2) is the viscosity of the toner at 90° C., and η(T3) is the viscosity of the toner at 130° C.
